(19) United States
(12) Patent Application Publication
(10) Pub. No.: US 2010/0058476 A1
(43) Pub. Date: Mar. 4, 2010

(54) Electronic information retention method/system, electronic information split retention method/system, electronic information split restoration processing method/system, and programs for the same

(76) Inventor: Kazuyoshi Isoda, Fukui (JP)

Correspondence Address: FLYNN THIEL BOUTELL & TANIS, P.C., 2026 RAMBLING ROAD, KALAMAZOO, MI, 49008-1631, US

(21) Appl. No.: 11/919,198

(22) PCT Filed: Apr. 27, 2006
(86) PCT No.: PCT/JP2006/308804

§ 371 Date: Oct. 24, 2007

(30) Foreign Application Priority Data
Apr. 28, 2005 (JP) 2005-131110
Apr. 25, 2006 (JP) 2006-121280

(51) Int. Cl. G06F 21/24

(52) U.S. Cl. 726/26; 713/165

(57) ABSTRACT

The invention aims to provide an electronic information split restoration processing method/system capable of processing massive electronic information at high speed while preventing leakage of the electronic information with reliability, and without causing deterioration in immediacy, centrally controlling electronic information to be processed by information processing units that are distributed geographically in a wide area, and connected via network. When electronic information is to be retained, a reversible split process and a reversible conversion process are applied to the electronic information (step S8), to thereby generate a plurality of split files (step S10), and store the split files together with dummy files (step S12). Split restoration information is generated (step S14) to be stored by relating processing information concerning the split and conversion process together with file names of the split files and information on storage destinations thereof, to data name of the original electronic information. When electronic information is to be read, split files are collected on the basis of the split restoration information (step S20) and the electronic information is restored by reversely applying the split and conversion process (step S22).

### TECHNICAL FIELD

The invention relates to an electronic information retention method/system, an electronic information split retention method/system, and an electronic information split restoration processing method/system, suitable for prevention of leakage of electronic information retained in an information processing unit such as a computer, and so forth, and programs for use in operation of the same.

### BACKGROUND TECHNOLOGY

Since electronic information is generally easy to be copied, there have occurred many incidents whereby massive data is taken out against the will of the owner thereof to be then put to use, be sold and bought. Strict control of electronic information is important in order to prevent such massive electronic information from being taken out.

As a method for preventing leakage of electronic information through centralized control of data, there is available a method whereby all the data is retained only in a specified server, and an information equipment called a thin client having no capacity of storing data is used in execution of business. Since the thin client fetches necessary data every time when the data is required, and is not structurally provided with a hard disk, and removable media, capable of storing data, it is difficult for a user of the thin client, or an intruder who has acquired the thin client to take out massive data by any method.

However, since the thin client need instantaneously fetch data from a server all the time, a high-speed network environment is indispensable. In an environment where a multitude of thin clients are distributed geographically in a wide area, if a server is installed at one location, it is necessary to install a fast data circuit for every thin client, in which case a communications cost becomes high due to costs of fast WAN circuits, in particular. For reduction in cost, it becomes necessary either to lower a data transfer rate, or to disperse servers to a number of locations. If the data transfer rate is lowered, this will impair immediacy of data acquisition in business, deteriorating operation efficiency. If the servers are dispersed to a number of locations, this will increase the risk of massive electronic information being taken out.

Problems of high costs and deterioration in immediacy, as described above, are attributable to the fact that there exists a spatial distance between equipment using data and equipment storing data, and massive data transfer occur therebetween.

As another method for preventing massive electronic information from being taken out, there is also available a method whereby electronic tallies are utilized. An electronic tally method is a kind of Secret Sharing Schemes (refer to Non-patent Document 1), and it is a method whereby electronic information is split into a plurality of pieces to be then stored at different places. Since the method has a mechanism for preventing restoration of the electronic information unless all or at least a given number of data blocks resulting from splitting of the electronic information are acquired, it is possible to lower the risk of data leakage by storing the data blocks at the different places as compared with the case where the data blocks are stored at one location. For example, in Patent Document 1, it is described that a plain text is read to be compressed and coded, thereby generating coded words by erasing redundant bit patterns, the coded words are cut into K-pieces of elements, the respective elements are portioned out to M-pieces of tally files on the basis of random numbers to be stored therein, a method for portioning out data is recorded in an element portioning table, the element portioning table is split into M-pieces to be added to the tally files, respectively, as closed headers, and a placement list of split pieces of the element portioning table, distributed to the closed header, on a tally file-by-tally file basis, is added to the respective tally files as an open header to thereby generate an electronic tally in the respective tally files to be then outputted as necessary.

Further, as a method for preventing unauthorized taking out of electronic information, there has been proposed a method whereby electronic information to be retained is split before storing the same. For example, in Patent Document 2, it is described that a portion of data is extracted out of a source file, and while an access key is produced on the basis of the portion of the data as extracted, there is generated a position information file storing information on a position which the portion of the data as extracted has occupied in the source file. In Patent Documents 3 and 4, it is described that a file is split into a plurality of files to be then dispersed to a plurality of storage units to be subsequently stored. Further, in Patent Document 5, it is described that source data is split into a plurality of data groups, and reference information and restoration information are added to the respective data groups, which are dispersed to a plurality of existing files to be added thereto, and stored. In Patent Document 6, it is described that electronic data to be treated as an original electronic file is split into at least 2 pieces to be then encrypted before being stored in electronic data storage as split files. In Patent Document 7, it is described that text data is compressed, and a storage file index is added thereto before splitting and coding the same to be then stored.

### Patent Document 1: JP 200453969 A

### Patent Document 2: JP 2004178312A

### Patent Document 3: JP 2000173178 A

### Patent Document 4: JP 2004171207 A

### Patent Document 5: JP 2001282621 A

### Patent Document 6: JP 2000172548 A

### Patent Document 7: JP 2002135247 A

Non-patent Document 1: “How to share a secret”, A. Shamir, Communications of the ACM, pp. 612-613, 1979

### DISCLOSURE OF THE INVENTION

The centralized control of electronic information, described as above, is an effective means for reducing the risk of electronic information leakage because equipment as a target for control is limited in this case. However, in the case where information processing units are geographically distributed in a wide area, the centralized storage of electronic information that is used in the information processing units by use of methods thus far devised will result in an increase in cost due to heavy use of fast WAN circuits, or deterioration in immediacy in data acquisition.

When centralized control of massive electronic information is carried out by use of the electronic tallies, there is adopted a method whereby portions of the electronic tallies are stored only in a specified information processing unit used for control. In the case of the method for utilizing the electronic tally method, however, even the procedure of portioning out the data, and so forth are also split and added to the plurality of the tally files generated by splitting, and portioning out the data. For this reason, as original electronic information increases in volume, so does the respective tally files in volume accordingly. Therefore, for the information processing units using electronic information to restore the data, it is required that the tally files fairly large in data volume be transferred from the specified information processing unit for control. In consequence, as is the case with the thin clients, in order to centrally control data in a multitude of the information processing units that are geographically distributed in a wide area, there occurs a problem of an increase in cost due to use of the fast WAN circuits, or deterioration in immediacy in data acquisition.

Further, with the method whereby the electronic information to be retained is split to be then stored, there is a demerit of an increase in data processing volume in the case where massive electronic information is split and stored to be then restored, as is the case of using the electronic tallies.

It is therefore an object of the invention to provide an electronic information retention method/system, an electronic information split retention method/system, and an electronic information split restoration processing method/system, together with programs for the same, all those being capable of processing massive electronic information at high speed while preventing leakage of the electronic information with reliability, and centrally controlling electronic information to be processed by information processing units that are geographically distributed in a wide area, and are connected to a network even by use of slow WAN circuits without causing deterioration in immediacy.

To that end, the invention provides an electronic information retention method comprising the step of generating dummy files indistinguishable from split files generated by applying a reversible data conversion process, and a reversible data split process to electronic information to be retained, and the step of storing the split files together with the dummy files.

The invention provides another electronic information retention method comprising the step of generating a plurality of dummy data blocks by applying a reversible data conversion process, and a reversible data split process to non-secret information, the step of generating a plurality of dummy files by providing the respective dummy data blocks as generated with file names, and the step of storing split files generated by applying a reversible data conversion process, and a reversible data split process to electronic information to be retained, together with the dummy files.

Said electronic information retention method preferably comprises the step of determining whether or not the number of files stored is not less than a predetermined number, and the step of generating the dummy files such that the number of the files stored will be not less than the predetermined number if it is determined that the number of the files stored is less than the predetermined number.

The invention provides an electronic information split retention method comprising the step of generating a plurality of split data blocks by applying a reversible data conversion process, and a reversible data split process, selected at random, to electronic information to be retained, the step of generating a plurality of split files by providing the respective split data blocks with file names at random, the step of storing the plurality of the split files generated together with dummy files indistinguishable from the respective split files, and the step of storing split restoration information generated by relating processing information concerning the data conversion process, and the data split process, as selected, together with the file names of the respective split files, and information on storage destinations thereof, to identification information on the electronic information.

The invention provides another electronic information split retention method comprising the step of generating a plurality of split data blocks by applying a reversible data conversion process, and a reversible data split process, selected at random, to electronic information to be retained, the step of generating a plurality of split files by providing the respective split data blocks with file names at random, the step of generating a plurality of dummy data blocks by applying a reversible data conversion process, and a reversible data split process to non-secret information, the step of generating a plurality of dummy files by providing the respective dummy data blocks generated with file names, the step of storing the plurality of the split files together with the dummy files, and the step of storing split restoration information generated by relating processing information concerning the data conversion process, and the data split process, as selected, together with the file names of the respective split files, and information on storage destinations thereof, to identification information on the electronic information.

With said electronic information split retention method, the split restoration information may be stored at storage destinations different from the storage destinations of the respective split files. Further, an encryption process is preferably applied to the split restoration information before storing the split restoration information.

The invention provides an electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of split files by providing the respective split data blocks with file names at random, the step of storing the plurality of the split files generated, together with dummy files indistinguishable from the respective split files, the step of storing split restoration information generated by relating processing information concerning the data conversion process, and the data split process, as selected, together with the file names of the respective split files, and information on storage destinations thereof, to identification information on the electronic information, the step of reading the split files on the basis of the file names of the respective split files, and the information on storage destinations thereof, contained in the relevant split restoration information corresponding to the identification information on the relevant electronic information, in response to a request for restoration of electronic information, and the step of executing restoration process for the split files as read on the basis of the processing information contained in the split restoration information.

The invention provides another electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of split files by providing the respective split data blocks with file names at random, the step of generating a plurality of dummy data blocks by applying a reversible data conversion process, and a reversible data split process to non-secret information, the step of generating a plurality of dummy files by providing the respective dummy data blocks generated with file names, the step of storing the plurality of the split files together with the dummy files, the step of storing split restoration information generated by relating processing information concerning the data conversion process, and the data split process, as selected, together with the file names of the respective split files, and information on storage destinations thereof, to identification information on the electronic information, the step of reading the split files on the basis of the file names of the respective split files, and the information on storage destinations thereof, contained in the relevant split restoration information corresponding to the identification information on the relevant electronic information, in response to a request for restoration of electronic information, and the step of executing restoration process for the split files as read on the basis of the processing information contained in the split restoration information.

The invention provides an electronic information retention system comprising a dummy file generation means for generating dummy files indistinguishable from split files generated by applying a reversible data conversion process, and a reversible data split process to electronic information, and a file retention means for retaining the split files together with the dummy files.

The invention provides another electronic information retention system comprising a dummy data generation means for generating a plurality of dummy data blocks by applying a reversible data conversion process, and a reversible data split process to non-secret information, a dummy file generation means for generating a plurality of dummy files by providing the respective dummy data blocks as generated, with file names, and a file storage means for storing a plurality of split files generated by applying a reversible data conversion process, and a reversible data split process to electronic information, together with the dummy files.

Said electronic information retention system preferably comprises a determination means for determining whether or not the number of files stored is not less than a predetermined number, and a file generation control means for generating the dummy files by controlling the dummy file generation means such that the number of the files stored will be not less than the predetermined number if it is determined that the number of the files stored is less than the predetermined number.

The invention provides an electronic information split retention system comprising a split data generation means for generating a plurality of split data blocks by applying a reversible data conversion process, and a reversible data split process to electronic information to be retained, a split file generation means for generating a plurality of split files by providing the respective split data blocks with file names, a file storage means for storing the plurality of the split files generated, together with dummy files indistinguishable from the respective split files, and a split restoration information generation means for generating split restoration information by relating processing information concerning the data conversion process, and the data split process, as selected, together with the file names of the respective split files, and information on storage destinations thereof, to identification information on the electronic information.

The invention provides another electronic information split retention system comprising a split data generation means for generating a plurality of split data blocks by applying a reversible data conversion process, and a reversible data split process to electronic information to be retained, a split file generation means for generating a plurality of split files by providing the respective split data blocks with file names, a dummy data generation means for generating a plurality of dummy data blocks by applying a reversible data conversion process, and a reversible data split process to non-secret information, a dummy file generation means for generating a plurality of dummy files by providing the respective dummy data blocks as generated with file names, a file storage means for storing the plurality of the split files together with the dummy files, and a split restoration information generation means for generating split restoration information by relating processing information concerning the data conversion process, and the data split process, as selected, together with the file names of the respective split files, and information on storage destinations thereof, to identification information on the electronic information.

The invention provides an electronic information split restoration processing system, comprising a split data generation means for generating a plurality of split data blocks by applying a reversible data conversion process, and a reversible data split process, selected at random, to electronic information to be retained, in response to a request for retention of the electronic information, a split file generation means for generating a plurality of split files by providing the respective split data blocks with file names at random, a file storage means for storing the plurality of the split files generated, together with dummy files indistinguishable from the respective split files, a split restoration information retention means for storing split restoration information generated by relating processing information concerning the data conversion process, and the data split process, as selected, together with the file names of the respective split files, and information on storage destinations thereof, to identification information on the electronic information, a split file collection means for reading the split files on the basis of the file names of the respective split files, and the information on storage destinations thereof, contained in the relevant split restoration information corresponding to the identification information on the relevant electronic information, in response to a request for restoration of electronic information, and a restoration processing means for executing restoration process for the split files as read on the basis of the processing information contained in the split restoration information.

The invention provides another electronic information split restoration processing system comprising a split data generation means for generating a plurality of split data blocks by applying a reversible data conversion process, and a reversible data split process, selected at random, to electronic information to be retained, in response to a request for retention of the electronic information, a split file generation means for generating a plurality of split files by providing the respective split data blocks with file names, a dummy data generation means for generating a plurality of dummy data blocks by applying a reversible data conversion process, and a reversible data split process to non-secret information, a dummy file generation means for generating a plurality of dummy files by providing the respective dummy data blocks generated, with file names, a file storage means for storing the plurality of the split files together with the dummy files, a split restoration information retention means for storing split restoration information generated by relating processing information concerning the data conversion process, and the data split process, as selected, together with the file names of the respective split files, and information on storage destinations thereof, to identification information on the electronic information, a split file collection means for reading the split files on the basis of the file names, and the information on storage destinations, contained in the relevant split restoration information corresponding to the identification information on the relevant electronic information, in response to a request for restoration of electronic information, and a restoration processing means for executing a restoration process for the split files as read on the basis of the processing information contained in the split restoration information.

The invention provides a program for enabling an electronic information retention system capable of retaining a plurality of split files generated by applying a reversible data conversion process, and a reversible data split process to electronic information to be retained to function, said program causing the electronic information retention system to function as a means for generating dummy files indistinguishable from the split files, and as a means for storing the split files together with the dummy files.

The invention provides another program for enabling an electronic information retention system capable of retaining a plurality of split files generated by applying a reversible data conversion process, and a reversible data split process to electronic information to be retained to function, said program causing the electronic information retention system to function as a means for generating a plurality of dummy data blocks by applying a reversible data conversion process, and a reversible data split process to non-secret information, as a means for generating a plurality of dummy files by providing the respective dummy data blocks as generated, with file names, and as a means for storing the split files together with the dummy files.

Said program preferably causes the electronic information retention system to function further as a means for determining whether or not the number of files stored is not less than a predetermined number, and as a means for controlling such that the dummy files are generated until the number of the files stored will be not less than the predetermined number if it is determined that the number of the files stored is less than the predetermined number.

The invention provides still another program for enabling an electronic information split retention system for splitting and storing electronic information to function, said program causing the electronic information split retention system to function as a means for generating a plurality of split data blocks by applying a reversible data conversion process, and a reversible data split process to electronic information to be retained, as a means for generating a plurality of split files by providing the respective split data blocks, with file names, as a means for storing the plurality of the split files generated, together with dummy files indistinguishable from the respective split files, and as a means for generating split restoration information by relating processing information concerning the data conversion process, and the data split process, as selected, together with the file names of the respective split files, and information on storage destinations thereof, to identification information on the electronic information.

The invention provides a further program for enabling an electronic information split retention system for splitting and storing electronic information to function, said program causing the electronic information split retention system to function as a means for generating a plurality of split data blocks by applying a reversible data conversion process, and a reversible data split process to electronic information to be retained, as a means for generating a plurality of split files by providing the respective split data blocks with file names, as a means for generating a plurality of dummy data blocks by applying a reversible data conversion process, and a reversible data split process to non-secret information, as a means for generating a plurality of dummy files by providing the respective dummy data blocks as generated, with file names, as a means for storing the plurality of the split files together with the dummy files, and as a means for generating split restoration information by relating processing information concerning the data conversion process, and the data split process, as selected, together with the file names of the respective split files, and information on storage destinations thereof, to identification information on the electronic information.

The invention provides a still further program for enabling an electronic information split restoration processing system for splitting and storing electronic information, and restoring the electronic information as split to function, said program causing the electronic information split restoration processing system to function as a means for generating a plurality of split data blocks by applying a reversible data conversion process, and a reversible data split process to electronic information to be retained, in response to a request for retention of the electronic information, as a means for generating a plurality of split files by providing the respective split data blocks, with file names, a means for storing the plurality of the split files generated, together with dummy files indistinguishable from the respective split files, as a means for storing split restoration information generated by relating processing information concerning the data conversion process, and the data split process, as selected, together with the file names of the respective split files, and information on storage destinations thereof, to identification information on the electronic information, a means for reading the split files on the basis of the file names, and the information on storage destinations, contained in the relevant split restoration information corresponding to the identification information on the relevant electronic information, in response to a request for restoration of electronic information, and as a means for executing a restoration process for the split files as read on the basis of the processing information contained in the split restoration information.

The invention provides a yet further program for enabling an electronic information split restoration processing system for splitting and storing electronic information, and restoring the electronic information as split to function, said program causing the electronic information split restoration processing system to function as a means for generating a plurality of split data blocks by applying a reversible data conversion process, and a reversible data split process to electronic information to be retained, in response to a request for retention of the electronic information, as a means for generating a plurality of split files by providing the respective split data blocks with file names, a means for generating a plurality of dummy data blocks by applying a reversible data conversion process, and a reversible data split process to non-secret information, as a means for generating a plurality of dummy files by providing the respective dummy data blocks generated, with file names, as a means for storing the plurality of the split files generated, together with the dummy files, as a means for storing split restoration information generated by relating processing information concerning the data conversion process, and the data split process, as selected, together with the file names of the respective split files, and information on storage destinations thereof, to identification information on the electronic information, a means for reading the split files on the basis of the file names, and the information on storage destinations, contained in the relevant split restoration information corresponding to the identification information on the relevant electronic information, in response to a request for restoration of electronic information, and as a means for executing a restoration process for the split files as read on the basis of the processing information contained in the split restoration information.

The invention provides another electronic information retention method comprising the step of generating dummy data blocks indistinguishable from respective split data blocks generated by applying a reversible data conversion process, and a reversible data split process to electronic information to be retained, and the step of storing the split data blocks, together with the dummy data blocks, in a database.

The invention provides another electronic information retention method comprising the step of generating a plurality of dummy data blocks by applying a reversible data conversion process, and a reversible data split process to non-secret information, and the step of storing split data blocks generated by applying a reversible data conversion process, and a reversible data split process to electronic information to be retained, together with the dummy data blocks, in a database.

Said electronic information retention method preferably comprises the step of determining whether or not the number of data blocks stored in the database is not less than a predetermined number, and the step of generating the dummy data blocks such that the number of the files stored will be not less than the predetermined number if it is determined that the number of the files stored is less than the predetermined number.

The invention provides another electronic information split retention method comprising the step of generating a plurality of split data blocks by applying a reversible data conversion process, and a reversible data split process, selected at random, to electronic information to be retained, the step of storing the plurality of the split data blocks generated, together with dummy data blocks indistinguishable from the respective split data blocks, and the step of storing split restoration information generated by relating processing information concerning the data conversion process, and the data split process, as selected, together with information on storage locations of the respective split data blocks, and information on storage destinations thereof, to identification information on the electronic information.

The invention provides a further electronic information split retention method comprising the step of generating a plurality of split data blocks by applying a reversible data conversion process, and a reversible data split process, selected at random, to electronic information to be retained, the step of generating a plurality of dummy data blocks by applying a reversible data conversion process, and a reversible data split process to non-secret information, the step of storing the split data blocks generated, together with the dummy data blocks, in a database, and the step of storing split restoration information generated by relating processing information concerning the data conversion process, and the data split process, as selected, together with information on storage locations of the respective split data blocks, and information on storage destinations thereof, to identification information on the electronic information.

With said electronic information split retention method, the split restoration information may be stored at storage destinations different from the storage destinations of the respective split data blocks. Further, an encryption process is preferably applied to the split restoration information before storing the split restoration information.

The invention provides another electronic information split restoration processing method comprising the step of generating a plurality of split data blocks by applying a reversible data conversion process, and a reversible data split process, selected at random, to electronic information to be retained in response to a request for retention of the electronic information, the step of storing the plurality of the split data blocks generated, together with dummy data blocks indistinguishable from the respective split data blocks, in database, the step of storing split restoration information generated by relating processing information concerning the data conversion process, and the data split process, as selected, together with information on storage locations of the respective split data blocks, and information on storage destinations thereof, to identification information on the electronic information, the step of reading the split data blocks on the basis of the information on the storage locations of the respective split data blocks, and the information on storage destinations thereof, contained in the relevant split restoration information corresponding to the identification information on the electronic information, in response to a request for restoration of electronic information, and the step of executing a restoration process for the split data blocks as read on the basis of the processing information contained in the split restoration information.

The invention provides still another electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of dummy data blocks by applying a reversible data conversion process, and a reversible data split process to non-secret information, the step of storing the plurality of the split data blocks generated, together with the dummy data blocks, in a database, the step of storing split restoration information generated by relating processing information concerning the data conversion process, and the data split process, as selected, together with information on storage locations of the respective split data blocks, and information on storage destinations thereof, to identification information on the electronic information, the step of reading the split data blocks on the basis of the information on the storage locations of the respective split data blocks, and the information on storage destinations thereof, contained in the relevant split restoration information corresponding to the identification information on the electronic information, in response to a request for restoration of electronic information, and the step of executing a restoration process for the split data blocks as read on the basis of the processing information contained in the split restoration information.

The invention provides another electronic information retention system comprising a dummy data generation means for generating dummy data blocks indistinguishable from a plurality of split data blocks generated by applying a reversible data conversion process, and a reversible data split process, to electronic information to be retained, and a data storage means for storing the split data blocks together with the dummy data blocks in a database.

The invention provides still another electronic information retention system comprising a dummy data generation means for generating dummy data blocks by applying a reversible data conversion process, and a reversible data split process to non-secret information, and a data storage means for storing a plurality of split data blocks generated by applying a reversible data conversion process, and a reversible data split process to electronic information to be retained, together with the dummy data blocks in a database.

Said electronic information retention system preferably further comprises a determination means for determining whether or not the number of data blocks stored in the database is less than a predetermined number, and a data generation control means for generating the dummy data blocks by controlling the dummy data generation means such that the number of the data blocks stored will be not less than the predetermined number if it is determined that the number of the data blocks stored is less than the predetermined number.

The invention provides another electronic information split retention system comprising a split data generation means for generating a plurality of split data blocks by applying a reversible data conversion process, and a reversible data split process to electronic information to be retained, a data storage means for storing the plurality of the split data blocks, together with dummy data blocks indistinguishable from the respective split data blocks, in a database, and a split restoration information generation means for generating split restoration information by relating processing information concerning the data conversion process, and the data split process, as selected, together with information on storage locations of the respective split data blocks, and information on storage destinations thereof, to identification information on the electronic information

The invention provides still another electronic information split retention system comprising a split data generation means for generating a plurality of split data blocks by applying a reversible data conversion process, and a reversible data split process to electronic information to be retained, a dummy data generation means for generating a plurality of dummy data blocks by applying a reversible data conversion process, and a reversible data split process to non-secret information, a data storage means for storing the plurality of the split data blocks generated, together with the dummy data blocks, in a database, and a split restoration information generation means for generating split restoration information by relating processing information concerning the data conversion process, and the data split process, as selected, together with information on storage locations of the respective split data blocks, and information on storage destinations thereof, to identification information on the electronic information.

The invention provides another, electronic information split restoration processing system, comprising a split data generation means for generating a plurality of split data blocks by applying a reversible data conversion process, and a reversible data split process to electronic information to be retained, in response to a request for retention of the electronic information, a data storage means for storing the plurality of the split data blocks generated, together with dummy data blocks indistinguishable from the respective split data blocks, in a database, a split restoration information retention means for storing split restoration information generated by relating processing information concerning the data conversion process, and the data split process, as selected, together with information on storage locations of the respective split data blocks, and information on storage destinations thereof, to identification information on the electronic information, a split data collection means for reading the split data blocks on the basis of the information on the storage locations of the respective split data blocks, and the information on the storage destinations thereof, contained in the relevant split restoration information corresponding to the identification information on the relevant electronic information, in response to a request for restoration of electronic information, and a restoration processing means for executing a restoration process for the split data blocks as read on the basis of the processing information contained in the split restoration information.

The invention provides still another electronic information split restoration processing system, comprising a split data generation means for generating a plurality of split data blocks by applying a reversible data conversion process, and a reversible data split process to electronic information to be retained, in response to a request for retention of the electronic information, a dummy data generation means for generating a plurality of dummy data blocks by applying a reversible data conversion process, and a reversible data split process to non-secret information, a data storage means for storing the plurality of the split data blocks together with the dummy data blocks, in a database, a split restoration information retention means for storing split restoration information generated by relating processing information concerning the data conversion process, and the data split process, as selected, together with information on storage locations of the respective split data blocks, and information on storage destinations thereof, to identification information on the electronic information, a split data collection means for reading the split data blocks on the basis of the information on the storage locations of the respective split data blocks, and the information on the storage destinations thereof, contained in the relevant split restoration information corresponding to the identification information on the relevant electronic information, in response to a request for restoration of electronic information, and a restoration processing means for executing a restoration process for the split data blocks as read on the basis of the processing information contained in the split restoration information.

The invention provides another program for enabling an electronic information retention system capable of storing a plurality of split data blocks generated by applying a reversible data conversion process, and a reversible data split process to electronic information to be retained, in a database, to function, said program causing the electronic information retention system to function as a means for generating dummy data blocks indistinguishable from the split data blocks, and as a means for storing the split data blocks, together with the dummy data blocks, in the database.

The invention provides still another program for enabling an electronic information retention system capable of storing a plurality of split data blocks generated by applying a reversible data conversion process, and a reversible data split process to electronic information to be retained, in a database, to function, said program causing the electronic information retention system to function as a means for generating a plurality of dummy data blocks by applying a reversible data conversion process, and a reversible data split process to non-secret information, and as a means for storing the split data blocks together with the dummy data blocks, in a database.

Said program preferably causes the electronic information retention system to function further as a means for determining whether or not the number of data blocks stored in the database is less than a predetermined number, and as a means for controlling such that the dummy data blocks are generated until the number of the data blocks stored will be not less than the predetermined number if it is determined that the number of the data blocks stored is less than the predetermined number.

The invention provides a further program for enabling an electronic information split retention system for splitting electronic information to be stored in a database, to function, said program causing the electronic information split retention system to function as a means for generating a plurality of split data blocks by applying a reversible data conversion process, and a reversible data split process to electronic information to be retained, as a means for generating dummy data blocks indistinguishable from the split data blocks generated, as a means for storing the split data blocks, together with the dummy data blocks, in the database, and as a means for generating split restoration information by relating processing information concerning the data conversion process, and the data split process, as selected, together with information on storage locations of the respective split data blocks, and information on storage destinations thereof, to identification information on the electronic information.

The invention provides a still further program for enabling an electronic information split retention system for splitting electronic information to be stored in a database, to function, said program causing the electronic information split retention system to function as a means for generating a plurality of split data blocks by applying a reversible data conversion process, and a reversible data split process to electronic information to be retained, as a means for generating a plurality of dummy data blocks by applying a reversible data conversion process, and a reversible data split process to non-secret information, as a means for storing the split data blocks generated, together with the dummy data blocks, in a database, and as a means for generating split restoration information by relating processing information concerning the data conversion process, and the data split process, as selected, together with information on storage locations of the respective split data blocks, and information on storage destinations thereof, to identification information on the electronic information.

The invention provides a yet further program for enabling an electronic information split restoration processing system for splitting electronic information to be stored in a database, and restoring the electronic information as split, said program causing the electronic information split restoration processing system to function as a means for generating a plurality of split data blocks by applying a reversible data conversion process, and a reversible data split process to electronic information to be retained, in response to a request for retention of the electronic information, as a means for storing the plurality of the split data blocks generated, together with dummy data blocks indistinguishable from the respective split data blocks, in the database, as a means for storing split restoration information generated by relating processing information concerning the data conversion process, and the data split process, as selected, together with information on storage locations of the respective split data blocks, and information on storage destinations thereof, to identification information on the electronic information, as a means for reading the split data blocks on the basis of the information on the storage locations, and the information on the storage destinations, contained in the relevant split restoration information corresponding to the identification information on the relevant electronic information, in response to a request for restoration of the electronic information, and as a means for executing a restoration process for the split data blocks as read on the basis of the processing information contained in the split restoration information.

The invention provides another program for enabling an electronic information split restoration processing system for splitting electronic information to be stored in a database, and restoring the electronic information as split, said program causing the electronic information split restoration processing system to function as a means for generating a plurality of split data blocks by applying a reversible data conversion process, and a reversible data split process to electronic information to be retained, in response to a request for retention of the electronic information, as a means for generating a plurality of dummy data blocks by applying a reversible data conversion process, and a reversible data split process to non-secret information, as a means for storing the plurality of the split data blocks generated, together with the dummy data blocks, in a database, as a means for storing split restoration information generated by relating processing information concerning the data conversion process, and the data split process, as selected, together with information on storage locations of the respective split data blocks, and information on storage destinations thereof, to identification information on the electronic information, as a means for reading the split data blocks on the basis of the information on the storage locations, and the information on the storage destinations, contained in the relevant split restoration information corresponding to the identification information on the relevant electronic information, in response to a request for restoration of the electronic information, and as a means for executing a restoration process for the split data blocks as read on the basis of the processing information contained in the split restoration information.

With the invention, only relatively simple processes, such as the reversible data conversion process, and the reversible data split process, are applied to electronic information to be retained, however, if the split files generated by processing as above are retained together with the dummy files indistinguishable from the respective split files, this will render it difficult to restore the electronic information when an attempt is made to gain an unauthorized access to the electronic information as retained.

Suppose, for example, a case where 10 pieces of split files are generated by applying the reversible data conversion process, and the reversible data split process to original electronic information to be then retained together with 10,000 pieces of dummy files indistinguishable from the split files, in a folder. The number of the combinations of 10 pieces of files taken out from 10,010 pieces of files is approximately 2.77×10³³. Accordingly, if file names after splitting are unknown although it is known that the 10 pieces of the split files are generated, it is necessary to try all the combinations of 10 pieces of the files taken out from 10,010 pieces of the files. Furthermore, if it is not known that the 10 pieces of the split files are generated out of the original electronic information, it is necessary to try all the combinations of 1 piece of the file or more chosen from 10,010 pieces of the files at a time, that is, all the combinations of (2¹⁰⁰¹⁰-1) pieces. This amounts to approximately the combinations of 2.04×10³⁰¹³ pieces, and there is not even the remotest possibility of trying all the combinations.

Thus, if the split files are retained together with the dummy files indistinguishable from the respective split files, this will render it possible to have the split files embedded in the dummy files to thereby conceal the split files, and the number of the combinations required for elucidation of the split files can be easily increased in magnitude to 10 raised to the several hundredth power, or the several thousandth power. In consequence, it will become extremely difficult to identify the split files generated from electronic information.

The dummy files indistinguishable from the split files are the same in kind as the split files, and cannot be distinguished from the latter on the basis of data content, data size, and so forth. For example, if the split files each are made up of a meaningless data row, the respective dummy files as well will have a data row, which is similarly a meaningless data row. The dummy files can be generated through rearrangement of data rows of non-secret information, or by use of random numbers. If the dummy files are generated by applying the reversible data conversion process, and the reversible data split process to non-secret information as is the case with the split files, this will render the dummy files utterly indistinguishable. For the non-secret information, use is sufficiently made of information disclosed over the Internet, information on documents having no confidentiality, and so forth.

Further, if parameters for use in processing are varied in the case of the reversible data conversion process, and the reversible data split process, it is possible to set a multitude of kinds of processing methods, so that a processing method is selected from among the multitude of the processing methods, and the number of times a plurality of the processing methods are differently combined together can be optionally set. Accordingly, even if the individual processing methods are simple, the number of processing patterns will become enormous through selection from among the multitude of the processing methods, and combination of the selected. As a result, it is extremely difficult to restore original electronic information from the split files generated.

Accordingly, with the invention, it is possible to sufficiently withstand an attack through an unauthorized access, intending to cause leakage of electronic information, even if the split files are not decentralized for storage, and to ensure very high confidentiality. In consequence, the split files can be stored in user's information processing unit, and/or peripheral units thereof, and data of the split files is not transferred over a network in contrast to the case of a system based on the secret sharing schemes, so that even if massive electronic information is treated with the split and retention procedure, it can be handled sufficiently with slow communication circuits without causing deterioration in immediacy. Accordingly, massive electronic information can be retained without causing an increase in cost while maintaining high confidentiality.

Because split restoration information generated by relating processing information concerning the data conversion process, and the data split process, as selected, together with file names of the respective split files, and information on storage destinations thereof, to identification information on the electronic information is sufficient for restoring electronic information from the files split and retained as described in the foregoing, it need only be sufficient to store and control data on the order of several hundred bytes at most in size. For this reason, even if a number of pieces of split restoration information are exchanged over slow communication circuits in the case of centralized control, a problem of deterioration in immediacy does not occur at all. Since the data involved is small in size, a powerful encryption process can be applied thereto, so that vary high security can be ensured.

Further, when the split data blocks generated by applying the reversible data conversion process, and the reversible data split process to electronic information to be retained are stored in a database, together with the dummy data blocks indistinguishable from the respective split data blocks, it is extremely difficult to identify the split data blocks as is the case with the split files described as above, and it is also extremely difficult to restore the electronic information, so that high confidentiality can be ensured. Further, in the case of storing the split data blocks in the database, it is possible to retrieve the same at a high speed as compared with the case of storing the same as the split files, thereby enhancing a processing speed. Furthermore, if respective data blocks are hierarchically stored in the database, this will render it difficult to easily find out the number of the data blocks stored, thereby ensuring still higher confidentiality.

The electronic information to be retained includes all information having a good likelihood that it need be concealed, such as data on document files, data on data files, data on images, and so forth.

### BEST MODE FOR CARRYING OUT THE INVENTION

Embodiments of the invention are described hereinafter with reference to the attached drawings. Since those embodiments described hereinafter are preferred specific examples in carrying out the invention, various technical limitations are applied thereto. It is to be pointed out, however, that the invention is not limited thereto unless explicitly stated otherwise in the following description.

### First Embodiment

### (1) The Gist of Split and Restoration Process for Electronic Information

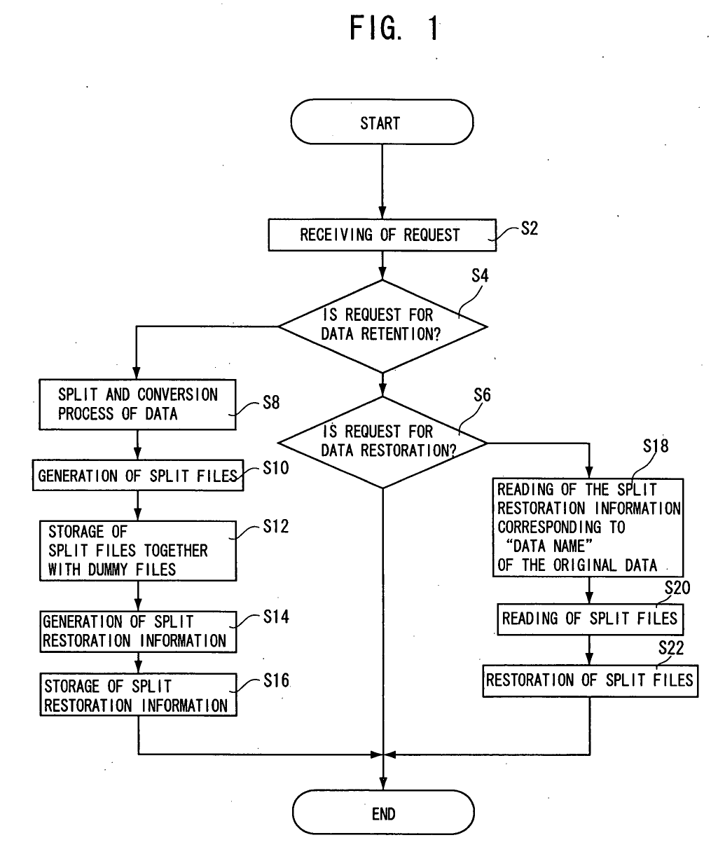

FIG. 1 is a flow chart showing a split and restoration process flow for electronic information, according to the first embodiment of the invention. The split and restoration process for electronic information is started upon a front-end program receiving a request for processing (step S2). The front-end program first checks an access right of a request sender, and if the request sender does not have the access right, the request is rejected. There is shown the process hereinafter if the access right exists.

If the request is a request for data retention (step S4), the front-end program runs a process for delivering electronic information to a data split program.

The data split program generates split data blocks by applying a reversible split and conversion process to electronic information intended for retention (step S8), providing the respective split data blocks with file names at random to thereby generate a plurality of split files (step S10). The split and conversion process is selected at random among a multitude of reversible data conversion processes, and reversible data split processes, and parameters involved in processing are also generated at random. By so doing, it becomes difficult for anyone to surmise the split and conversion process applied to the electronic information.

Next, the split files as generated, together with dummy files, are stored in a retention folder (step S12). The dummy files are the same in kind as the split files, and cannot be distinguished from the latter on the basis of data content, data size, and so forth. For example, if the split files each are made up of a meaningless data row, the respective dummy files as well will have a data row, which is similarly a meaningless data row. The dummy files can be generated through rearrangement of data rows of non-secret information, or by use of random numbers. It need only be sufficient to generate the dummy files by applying the reversible data conversion process, and the reversible data split process to non-secret information as is the case with the split files.

As will be described later, if the number of the files existing in the retention folder is short of a predetermined number, dummy data blocks in number corresponding to such shortage are generated by use of a dummy data generation program to be then stored. By virtue of such processing, it is ensured that not less than the predetermined number of files always exist in the retention folder, and the number of the combinations of the files taken at random from the retention folder to be combined together can reach into an astronomical figures not less than a given number.

With a dummy data generation program, a split and conversion processing method is selected by an unpredictable way based on random numbers among the multitude of the reversible data conversion processes, and reversible data split processes and dummy data blocks are generated by applying the split and conversion processing method to optional data having significance although having no secrecy as with the case of the data split program. The respective dummy data blocks as generated are provided with file names, thereby generating dummy files. By virtue of such processing, in case there occurs an unauthorized access attempting to take out electronic information, it is possible to prevent the dummy files in a retention folder from being identified due to any feature thereof to be then excluded.

At the time of processing for file retention, the last modified date and time are recorded, but the last modified date and time for all the files in the retention folder are rendered identical to each other all the time, or are not retained at all. With the invention, it is important that the split files as generated from certain electronic information are not distinguishable from the other files stored in the retention folder.

Upon completion of the storage of the split files, the data split program generates “split restoration information” for relating “split and conversion rule”, that is, processing information showing how original electronic information is converted and split, together with the file names of the respective split files, and respective names of storage units, that is, information on storage destinations, to data names, that is, identification information on the original electronic information (step S14), thereby transmitting the “split restoration information” to a split restoration information retention program via encrypted communication paths. According to the split restoration information retention program, the “split restoration information” is stored in files or a database (step S16). The above completes a split and retention process of electronic information.

Next, if a request received by the front-end program is a request for data restoration (step S6), the front-end program reads a “data name” of electronic information under request, transmitting the same to a data restoration program.

The data restoration program transmits the “data name” of the electronic information to the split restoration information retention program via the encrypted communication paths, and the split restoration information retention program reads the “split restoration information” corresponding to the “data name” to be then transmitted to the data restoration program (step S18).

The data restoration program reads, and collects the split files from the retention folder on the basis of the file names of the respective split files, and names of the storage processing units thereof, in the “split restoration information” (step S20), and executes processing by reversely applying the “split and conversion rule” in the “split restoration information” to thereby restore the original electronic information (step S22). Since the data conversion process and the data split process, specified in the “split and conversion rule”, are all reversible, a restoration process can be accurately executed all the time.

The data restoration program transmits the electronic information as restored to the front-end program, and the front-end program transmits the electronic information as received to the request sender. By so doing, the restoration process for the electronic information split and retained is completed.

With the invention, the split files of electronic information are all stored in one retention folder, or a plurality of the retention folders. Accordingly, the split files of electronic information can be stored in the information processing unit for processing electronic information, or in the vicinity thereof, so that it is unnecessary to exchange massive data as split via communication circuits unlike the case of Secret Sharing Schemes, thereby enabling both reduction in communication cost, and high immediacy due to fast processing of data to be implemented. The above represents a first good point of the invention.

Further, even assuming that the retention folder storing the split files is taken out through unauthorized access, it is extremely difficult to restore original electronic information out of files stored in the retention folder unless the “split restoration information” strictly retained and controlled by the split restoration information retention program is acquired. The reason for that is described hereinafter by citing a specific example.

Suppose a set value of the minimum number of files stored in a retention folder is 10,000, and 10,000 pieces of the files are stored in the retention folder. Then, assuming that 10 pieces of split files are generated by subjecting certain electronic information to the split and conversion process, and are stored in the retention folder. In this case, the number of the files after the split files are stored will be 10,010 pieces in total.

If the retention folder is taken out through unauthorized access, and an attempt is made to restore original electronic information out of the files taken out. The number of the combinations of 10 pieces of the files chosen from 10,010 pieces of the files at a time will be approximately 2.77×10³³ even if it is known that the 10 pieces of the split files are generated out of the original electronic information. The computational speed of the world's fastest computer being about 70 TFLOPS as of April, 2005. It will take about 8.79×10¹¹ years for processing to complete the combinations for selecting only the 10 pieces of the files even on the assumption that 10¹⁴ pieces of the combinations can be produced in a second.

If it is not known that the 10 pieces of the split files are generated out of the original electronic information, the number of the combinations of 1 piece of the file or more chosen from 10,010 pieces of the files at a time will be approximately 2.04×10³⁰¹³, indicating that it is meaningless even to discuss the possibility of producing the combinations.

Accordingly, unless the “split restoration information” retained and controlled by the split restoration information retention program is taken possession of, it becomes practically impossible to restore the original electronic information out of the files stored in the retention folder. The above represents a second good point of the invention.

On the other hand, if the “split restoration information” retained and controlled by the split restoration information retention program is acquired, the data restoration process can be executed with great ease since procedure employed in the split and conversion process is all reversible processing, and is a simple operation on a bit string. Even the information processing unit low in processing capacity is able to execute the processing at high speed. The above represents a third good point of the invention.

With the invention, there is no necessity of data retention at a plurality of locations, which is generally essential in the case of Secret Sharing Schemes, and it need only be sufficient to carry out centralized control of only the “split restoration information” retained and controlled by the split restoration information retention program. It is possible to reduce a control cost associated with the data retention. The above represents a fourth good point of the invention.

### (2) System Configuration in Whole, and the Gist of Operation

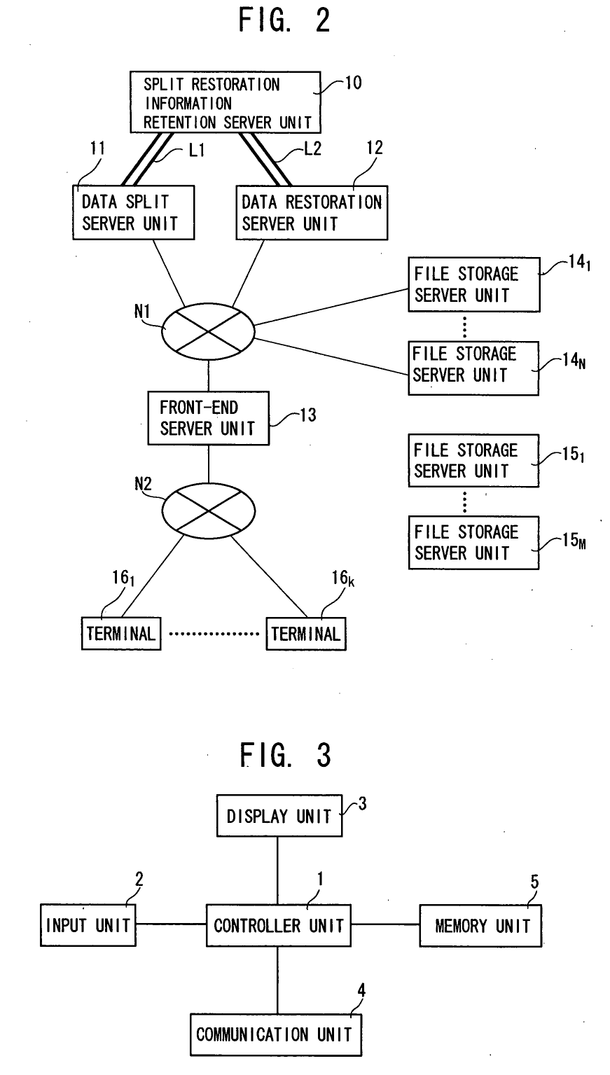

FIG. 2 is a block diagram showing a system configuration in whole, according to the first embodiment of the invention. All server units, and terminals, other than a split restoration information retention server unit 10, are connected to a LAN via networks N1 and N2. LAN connection is made between the split restoration information retention server unit 10, and a data split server unit 11 as well as between the split restoration information retention server unit 10, and a data restoration server unit 12 if a distance therebetween is short, and if the distance is long, connection therebetween is made via a WAN communication circuit, thereby enabling signals to be exchanged via encrypted communication paths L1 and L2, respectively.

The encrypted communication paths L1 and L2 are shown in the figure as two different communication paths, indicating that those are communication paths different from each other in terms of logical level. Those paths may be one and the same communications path in physical terms. Further, it is crucial that encrypted data exchange is executed through the encrypted communication paths L1 and L2, and those paths may be any circuit among a dedicated line, the Internet, LAN, wireless LAN, and so forth in physical terms.

Terminals 16₁ . . . 16ₖ are for use in execution of operation by processing electronic information. The request for data retention of electronic information or data restoration of electronic information, is sent from the terminals 16₁ . . . 16ₖ, respectively, to a front-end server unit 13 via the network N2.

The front-end program is installed in the front-end server unit 13. The front-end server unit 13 having received the request first checks the access right of the request sender. If the access right does not exist, the request is rejected by the front-end server unit 13. If the access right exists, the front-end server unit 13 next examines whether the request is a request for data retention or a request for data restoration.

If the request is a request for data restoration, “data name”, that is, identification information on electronic information to be restored is sent from the terminal, and then the front-end server unit 13 transmits the received “data name” of the electronic information to the data restoration server unit 12.

The data restoration program is installed in the data restoration server unit 12. Upon the data restoration server unit 12 receiving the “data name” of the electronic information from the front-end server unit 13, the data restoration server unit 12 sends the “data name” of the electronic information to the split restoration information retention server unit 10 via the encrypted communication path L2. The split restoration information retention server unit 10 reads the “split restoration information” corresponding to the received “data name” of the electronic information, and sends the “split restoration information” as read to the data restoration server unit 12 via the encrypted communication path L2.

Next, the data restoration server unit 12 reads split files from file storage server units 14₁ . . . 14_{N}, and 15₁ . . . 15_{M}, respectively, on the basis of the file names of the respective split files, and the information on storage destinations thereof, in the “split restoration information”, then restoring the original electronic information by processing through reverse application of the “split and conversion rule” in the “split restoration information”. Then, the data restoration server unit 12 sends the electronic information as restored to the front-end server unit 13.

The front-end server unit 13 sends the electronic information received from the data restoration server unit 12 to the terminal of the request sender to thereby enable the request sender to read and process the electronic information on the terminal.

If the request is the request for data retention, electronic information to be retained is sent from the terminal, then the front-end server unit 13 sends the electronic information as received to the data split server unit 11.

The data split program is installed in the data split server unit 11. Upon the data split server unit 11 receiving the electronic information from the front-end server unit 13, the data split server unit 11 applies a reversible data conversion process, and a reversible data split process to the electronic information to be retained, thereby generating a plurality of split data blocks, and generating the split files by providing the respective split data blocks with file names at random, the split files being stored in the retention folders on the file storage server units 14₁ . . . 14_{N}, and 15₁ . . . 15_{M}, respectively. Decision on at which file storage server units, and under what file name the split files are stored is made by use of random numbers such that duplication of the file name is avoided.

The file storage server units 14₁ . . . 14_{N}, and 15₁ . . . 15_{M} each are a unit where the split files, together with the dummy files, are stored, and the dummy data generation program is installed therein. The dummy files indistinguishable from the split files are generated by the dummy data generation program, and when the split files are stored, the dummy files are generated and stored such that the number of the files stored in the retention folder is not less than a predetermined number all the time.

In a common server unit, the last modified date and time are recorded when a file is stored. However, in the file storage server units 14₁ . . . 14_{N}, and 15₁ . . . 15_{M}, respectively, the last modified date and time for all the files in the retention folder are rendered identical to each other all the time, or are not recorded at all. By executing such processing, the split files generated from certain electronic information become indistinguishable from other files stored in the retention folder.

In FIG. 2, the file storage server units 14₁ . . . 14_{N} are on the same network as the data split server unit 11, and the data restoration server unit 12 are on while the file storage server units 15₁ . . . 15_{M} are on the same network as the terminals 16₁ . . . 16ₖ are on. Thus, the file storage server units each can be placed anywhere, and there is no need for physical and logical access control, for prevention of data leakage. Accordingly, the file storage server units each can be set at an optimum place where data can be transferred at high speed, so that flexibility in system configuration will be increased.

Upon the completion of the storage of the split files, the data split server unit 11 generates the “split restoration information” concerning the electronic information processed, that is, information wherein the “split conversion rule” which is processing information showing how the original electronic information is converted and split, together with the file names of the respective split files, and the respective names of the storage units, as information on storage destinations thereof, are related to the data names, which is the identification information on the original electronic information. The “split restoration information” as generated is sent to the split restoration information retention server unit 10 via the encrypted communication path L1.

The split restoration information retention program is installed in the split restoration information retention server unit 10. Data is exchanged between the split restoration information retention server unit 10, and the data restoration server unit 12, and between the split restoration information retention server unit 10 and the data split server unit 11, via the encrypted communications paths L1 and L2, respectively.

If there occurs leakage of the split restoration information stored in the split restoration information retention server unit 10, the split files stored in the respective file storage server units will be identified, leading to leakage of the electronic information retained. Therefore, it is required to carry out physically and logically strict access control in the split restoration information retention server unit 10.

Upon receipt of the “data name” of electronic information from the data restoration server unit 12 via the encrypted communications path L2, the split restoration information retention server unit 10 reads the “split restoration information” corresponding to the received “data name” of electronic information, thereby sending the “split restoration information” to the data restoration server unit 12. Further, the split restoration information retention server unit 10 stores the “split restoration information” received from the data split server unit 11 via the encrypted communication path L1 in files or databases.

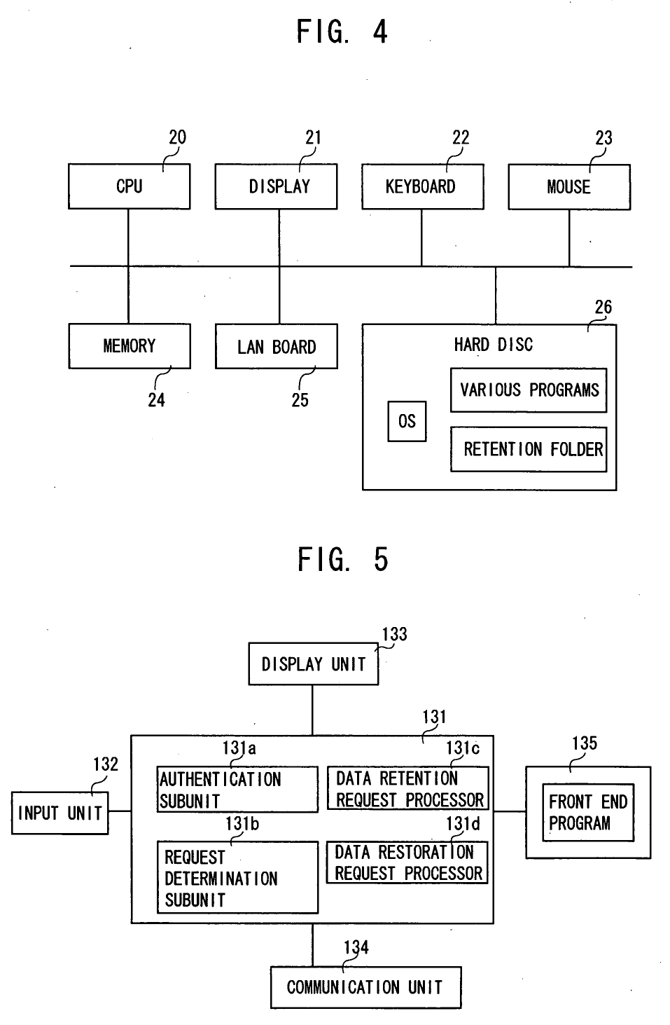

FIG. 3 is a block diagram concerning all the server units, and the terminals. An input unit 2, and a display unit 3 are used for various input/output to execute operation in the case of the terminals, and are used for input of various commands, and so forth, and display of a server unit state, and so forth for the purpose of control in the case of the server units. In a memory unit 5 of the server units, an operating system (OS) is installed, and the front-end program, the data split program, the data restoration program, the split restoration information retention program, the dummy data generation program, and so forth are stored, depending on functions executed on the respective server units. A controller unit 1 of the server units reads the operating system stored in the memory unit 5 to thereby execute control processing of the respective units in whole, and reads the respective programs, thereby implementing the functions thereof. In the case of the file storage server units, the split files and the dummy files are stored in the retention folder of the memory unit 5. In the split restoration information retention server unit 10, the “split restoration information” is stored in the memory unit 5. With respect to the terminals, the memory unit 5 may not necessarily be present. A communication unit 4 is for use in sending and receiving various data in all the server units and the terminals.

### (3) Hardware Makeup

FIG. 4 shows an example of hardware makeup having implemented the block diagram shown in FIG. 3. A CPU 20, and a memory 24, corresponding to the controller unit 1, a keyboard 22, and a mouse 23, corresponding to the input unit 2, a display 21 such as a liquid crystal display, and so forth, corresponding to the display unit 3, a LAN board 25, corresponding to the communication unit 4, and a hard disk 26, corresponding to the memory unit 5, are mutually connected to each other via a data transmission path.

### (4) Front-end Server Unit

FIG. 5 is a block diagram concerning the front-end server unit 13. As described above, the front-end server unit 13 comprises a controller unit 131, an input unit 132, a display unit 133, a communication unit 134, and a memory unit 135. The controller unit 131 consists of an authentication subunit 131a, a request determination subunit 131b, a data retention request processor 131c, and a data restoration request processor 131d. Respective functions of those parts of the controller unit 131 are implemented by reading the front-end program stored in the memory unit 135.

The authentication subunit 131a checks an access right of a terminal making a request for access, and the request determination subunit 131b determines whether the request received is the request for data retention or the request for data restoration. The data retention request processor 131c sends electronic information to the data split server unit 11 in response to the request for data retention. The data restoration request processor 131d sends the “data name” of electronic information received from the terminal in response to the request for data restoration to the data restoration server unit 12, and sending restored electronic information received from the data restoration server unit 12 to the terminal.

The request for data retention of electronic information, and the request for data restoration of electronic information, received from the respective terminals, are all sent to the front-end server unit 13, which serves as an input/output port for all the electronic information.

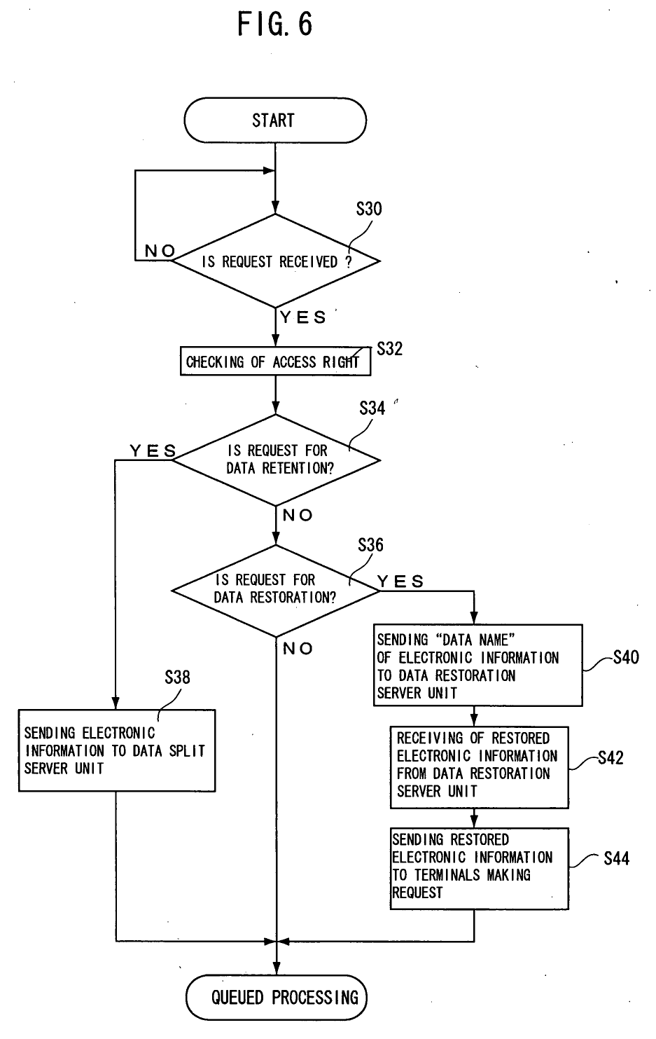

FIG. 6 is a flow chart showing a process flow at the front-end server unit 13. The front-end server unit 13 examines whether or not requests from the respective terminals are received (step S30). When a request is received, the front-end server unit 13 checks the access right (step S32). If the access right does not exist, the request is rejected.

If the access right exists, the front-end server unit 13 examines whether the request is the request for data retention of electronic information (step S34). If so, the front-end server unit 13 sends the electronic information to the data split server unit 11 (step S38). In this case, the electronic information received from the terminals is temporarily retained in a memory of the controller unit 131, but not stored in the memory unit 135 such as a hard disk, and so forth.

If the request is not the request for data retention of electronic information in the step S34, the front-end server unit 13 examines whether the request is the request for data restoration of electronic information (step S36). If so, the front-end server unit 13 sends the “data name” of an original electronic information received from the terminals to the data restoration server unit 12 (step S40) to make a request for data restoration, thereby receiving restored electronic information from the data restoration server unit 12 (step S42). In this case, the electronic information received from the terminals is temporarily retained in the memory of the controller unit 131, but not stored in the memory unit 135 such as a hard disk, and so forth. Then, the electronic information as received is sent to the terminals making the request (step S44).

### (5) Data Split Server Unit

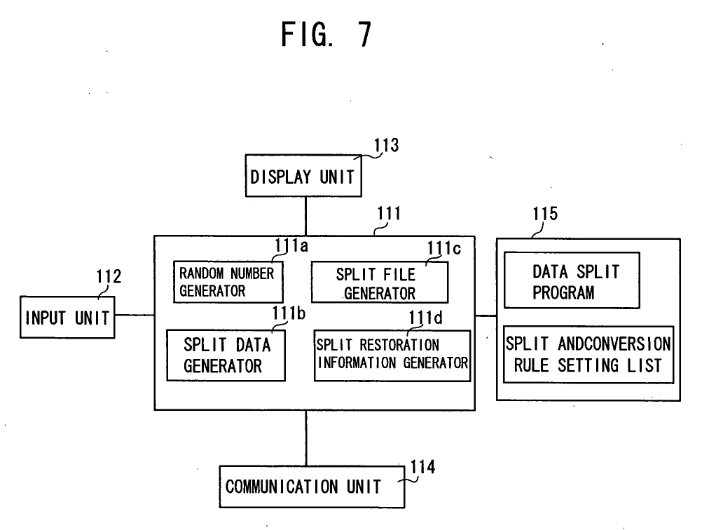

FIG. 7 is a block diagram concerning the data split server unit 11. As described above, the data split server unit 11 comprises a controller unit 111, an input unit 112, a display unit 113, a communication unit 114, and a memory unit 115. The controller unit 111 consists of a random number generator 111a, a split data generator 111b, a split file generator 111c, and a split restoration information generator 111d. Respective functions of those parts of the controller unit 111 are implemented by reading the data split program stored in the memory 115. A split and conversion rule setting list for use in generation of the split data blocks is also stored in the memory unit 115.

The random number generator 111a generates random numbers in the case of selecting a data conversion process, and a data split process at random upon making a split and conversion rule for generation of the split data blocks, in the case of providing split files with file names at random, and in the case of selecting respective storage destinations of the split files at random. The split data generator 111b makes a split and conversion rule by selecting a reversible data conversion process, and a data split process at random, and executes processing of electronic information to be retained on the basis of the split and conversion rule, thereby generating a plurality of split data blocks. The split file generator 111c provides the respective split data blocks as generated with file names at random to thereby generate split files, and selects at random the storage destinations of the respective split files as generated before sending the split files to the respective storage destinations as selected. The split restoration information generator 111d relates the split and conversion rule used in the split data generator 111b, together with the file names of the split files, and the storage unit names, that is, the information on the storage destinations of the respective split files, used in the split file generator 111c, to the “data name” of electronic information received from the front-end server unit 13, thereby generating the split restoration information.

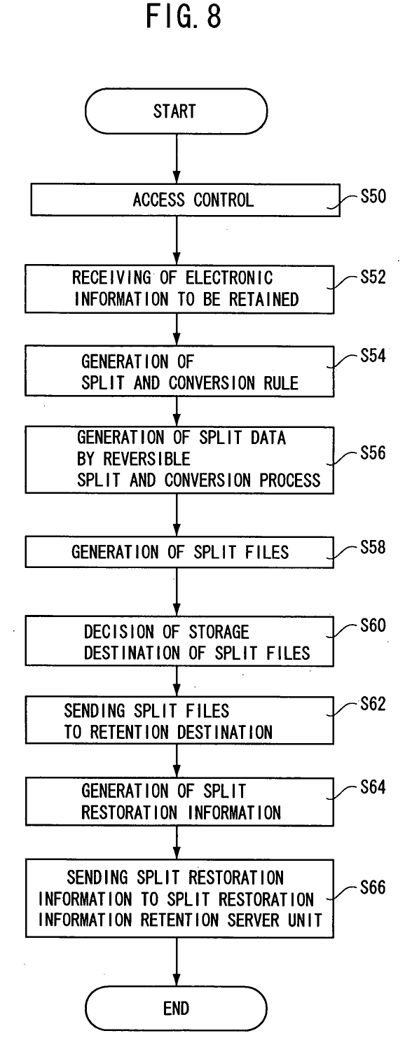

FIG. 8 is a flow chart showing a process flow at the data split server unit 11. First, the data split server unit 11 examines whether an access is made from the truly authorized front-end server unit 13 to thereby execute access control as necessary (step S50). If it turns out that there is any problem as a result of the access control, processing by the program is suspended.

If there exists no problem with the access control, the data split server unit 11 receives electronic information to be retained, from the front-end server unit 13 (step S52). In this case, the electronic information received from the terminals is temporarily retained in a memory of the controller unit 111, but not stored in the memory unit 115 such as a hard disk, and so forth.

Next, the data split server unit 11 selects a reversible data conversion process, and a data split process at random by use of the split and conversion rule setting list stored in the memory unit 115, thereby generating a split and conversion rule (step S54). Then, processing is applied to the retained electronic information on the basis of the split and conversion rule, thereby generating a plurality of the split data blocks (step S56).

Specific processing method for the split and conversion process in order to generate the split data blocks is described in detail hereinafter. First, a reversible conversion process is applied to a bit string of electronic information in the first stage of the split and conversion process. The reversible conversion process may be any process provided that it is reversible without causing loss of data.

Examples of the reversible conversion process are shown hereunder.

### <Conversion Process 1>

conversion name: T1 (d, m, n)
conversion rule 1: The data name before conversion is assumed as “d”. The data name after conversion is not changed, remaining as “d”.
conversion rule 2: A bit string from the m-th bit to the n-th bit is compressed using zip.

### <Conversion Process 2>

conversion name: T2 (d, m, n)
conversion rule 1: The data name before conversion is assumed as “d”. The data name after conversion is not changed, remaining as “d”.
conversion rule 2: The bit string from the m-th bit to the n-th bit is rearranged in the reverse order.

### <Conversion Process 3>

conversion name: T3 (d, m, n)
conversion rule 1: The data name before conversion is assumed as “d”. The data name after conversion is not changed, remaining as “d”.
conversion rule 2: As to a bit string from the m-th bit to the n-th bit, 0 is inverted to 1, and 1 is inverted to 0.

### <Conversion Process 4>

conversion name: T4 (d, m, n)
conversion rule 1: The data name before conversion is assumed as “d”. The data name after conversion is not changed, remaining as “d”.
conversion rule 2: A random bit string of n bits in length is inserted at the m-th place.

### <Conversion Process 5>

conversion name: T5 (d, x)
conversion rule 1: The data name before conversion is assumed as “d”. The data name after conversion is not changed, remaining as “d”.
conversion rule 2: A decimal number x is converted into a binary digit to be added up.

For example, assuming that the data name of original electronic information is “zc442”, a conversion process whereby 0 is inverted to 1, and 1 is inverted to 0 in a range from the 221th bit to the 892th bit can be expressed as T3 (zc442, 221, 892), so that the same can be rendered a small piece of information of only several bytes long.

As an infinite number of kinds of reversible conversion processes are conceivable, those processes are put on the split and conversion rule setting list, and conversion processes are selected at random from the list. Further, parameters in the case of the respective conversion processes, for example, m and n in the case of the conversion process 1 may be set at random by use of random numbers.

The conversion process may be a single reversible conversion process, or a plurality of reversible conversion processes may be successively executed. For example, it is possible to execute conversion according to the conversion process 1 to be followed conversion according to the conversion process 2. In this case, description can be given such that T1 (zc442, 125, 2341)→T2 (zc442, 1541, 4267).

Thus, by selecting conversion processes at random from among very many conversion processes, variously combining those conversion processes as selected with each other, and setting even parameters thereof at random, it is possible to render it extremely difficult to restore an original data from a data after conversion. At the same time, processing information showing what conversion has been carried out in what order can be rendered small in capacity on the order of several tens of bytes.

In the second stage of the split and conversion process, there is executed a reversible split process for splitting the bit string of the electronic information, subjected to the conversion process, into a plurality of data blocks. For the split process, use may be made of any process provided that it is reversible without causing loss of data, and the number of data blocks that result from splitting can be freely set within a set range.

Examples of the reversible split process are shown hereunder.

### <Split Process 1>

split process name: D1 (d, i, e, f, g, h, . . . , k)
split rule 1: The data name before splitting is assumed as “d”.
split rule 2: “n” is an integer that is equal to or larger than 0.
split rule 3: to put the i*n-th bit of original data into data “e”
split rule 4: to put the (i*n+1)-th bit of the original data into data “f”
split rule 5: to put the (i*n+2)-th bit of the original data into data “g”
split rule 6: to put the (i*n+3)-th bit of the original data into data “h”
. . .
split rule (i+2): to put the (i*n+i−1)-th bit of the original data into data “k”

### <Split Process 2>

split process name: D2 (d, x, k, m, n, p, q, . . . , s)
split rule 1: The data name before splitting is assumed as “d”. A data is split into k pieces.
split rule 2: By taking out from the m-th decimal place to the n-th decimal place of an infinite decimal x in decimal notation, a sequence of numbers consisting of figures at respective places is made up. The h-th term of the sequence of numbers is designated as “ah”. Using a natural number k as a modulus, the remainder of ah is designated as
split rule 3: Starting with the first bit of data before splitting, put each bit into any data of data0, data 1, . . . , data (k−1).
split rule 4: to put the h-th bit of data before splitting into data bh
split rule 5: to change the name of the data block 0 to data block p, the name of the data block 1 to data block q, . . . , the name of the data block (k−1) to data block s.

Suppose, for example, an original data (data name: “zz441”) is split into 10 split data blocks, namely, data block0, data block1, data block2, . . . , data block9. The split rule whereby the (10*n+m)-th data block of the original data is put in data block m can be expressed as D1 (zz441, 10, 0, 1, 2, 3, 4, 5, 6, 7, 8, 9).

As an infinite number of kinds of reversible split processes are conceivable, those processes are put on the split and conversion rule setting list, and split processes are selected at random from the list. Further, parameters in the case of the respective split processes, for example, x, k, m, and n in the case of the split process 2, may be set at random within a range where no theoretical contradiction occurs, by use of random numbers.

The split process may be a single reversible split process, or a plurality of reversible split processes may be successively executed. For example, it is possible to execute splitting according to the split process 1 to be followed by splitting according to the conversion process 2. In this case, description can be given such that D1 (zz441, 10, 0, 1, 2, 3, 4, 5, 6, 7, 8, 9)→D2 (8, \sqrt{3}, 4, 111563, 252441, 8, 10, 11, 12). As a result of this process, the data is finally split into 13 blocks.

By selecting split processes at random from among many split processes, variously combining those split processes with each other, and setting even parameters thereof at random, as described above, it is possible to render it extremely difficult to restore original data from the data blocks after splitting. At the same time, processing information showing what splitting processes have been carried out in what order can be rendered small in capacity on the order of tens of bytes.

In the third stage of the split and conversion process, a reversible conversion process is applied to respective bit strings of the plurality of the split data blocks generated by the split process described above. The reversible conversion process to be applied to the split data blocks is selected at random to be then decided on.

The conversion process in the third stage is executed in the same way as the reversible conversion process applied in the first stage described above except that the target for processing is the data blocks after the split process, and may be any process provided that it is reversible without causing loss of data as is the case with the conversion process in the first stage. Further, since an infinite number of kinds of reversible conversion processes are conceivable as in the first stage, those processes are put on the split and conversion rule setting list, and conversion processes are selected at random from the list. Parameters in the case of the respective conversion processes, for example, m and n in the case of the conversion process 1 may be set at random by use of random numbers. In this case, the conversion process may be a single reversible conversion process, or a plurality of reversible conversion processes may be executed in succession, as with the case of the first stage.

As is the case with the first stage, by selecting conversion processes at random from among very many conversion processes, variously combining those conversion processes with each other, and setting even parameters thereof at random, it becomes extremely difficult to restore original data from data after conversion. At the same time, processing information showing what conversion has been carried out in what order can be rendered small in capacity on the order of tens of bytes.

The “split and conversion rule” is generated by putting together the conversion process in the first stage, the split process in the second stage, and the conversion process in the third stage, as described above. The “split and conversion rule” as generated can be rendered small in capacity in a range of tens of bytes to hundreds of bytes.

Next, a file name is generated at random for each of a plurality of the split data blocks generated by the split and conversion process. The respective split data blocks are provided with the file names to thereby generate the split files (step S58). Respective storage destinations of the split files are decided upon through selection at random from among the file storage server units preset as information on the storage destinations (step S60). In this case, the electronic information received from the terminals is temporarily retained in a memory of the controller unit 111, but not stored in the memory unit 115 such as a hard disk, and so forth.

Subsequently, a plurality of the split files generated are sent to the file storage server units as decided, respectively, to be processed for storage (step S62).

Next, the “split restoration information” is generated wherein the “split and conversion rule” which is the processing information concerning the split and conversion process, generated in the step S54, together with the file names of the respective split files, and the respective names of the storage units, as information on storage destinations thereof, are related to the “data name” of the original electronic information (step S64). The “split restoration information” as generated is sent to the split restoration information retention server unit 10 via the encrypted communication path L1 (step S66).

### (6) Data Restoration Server Unit

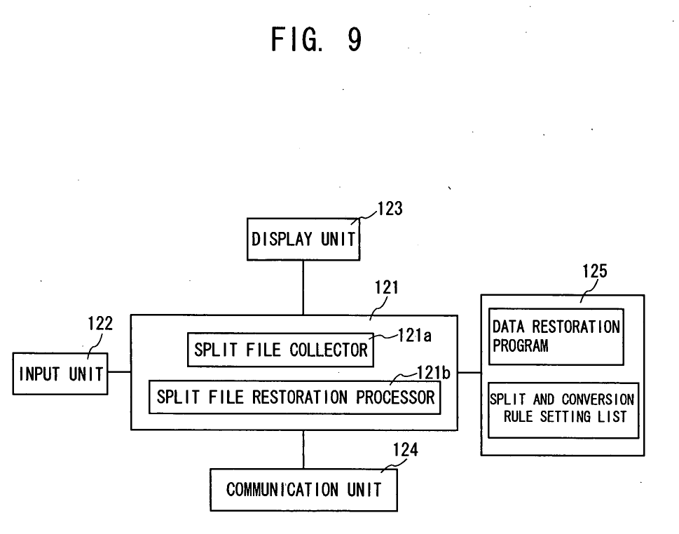

FIG. 9 is a block diagram concerning the data restoration server unit 12. As described above, the data restoration server unit 12 comprises a controller unit 121, an input unit 122, a display unit 123, a communication unit 124, and a memory unit 125. The controller unit 121 consists of a split file collector 121a, a split file restoration processor 121b. Respective functions of those parts of the controller unit 121 are implemented by reading the data restoration program stored in the memory unit 125. Further, the split and conversion rule setting list for use in a restoration process of the split files is stored in the memory unit 125.

The split file collector 121a reads the split files from the file storage server units on the basis of the file names of the respective split files, in the split restoration information as read, and the respective names of the retention units, which is information on the storage destinations, thereby collecting the split files. On the basis of the “split and conversion rule” in the split restoration information as read, the split file restoration processor 121b applies the split and conversion process in reverse to the split files collected, thereby executing the restoration process of the original electronic information.

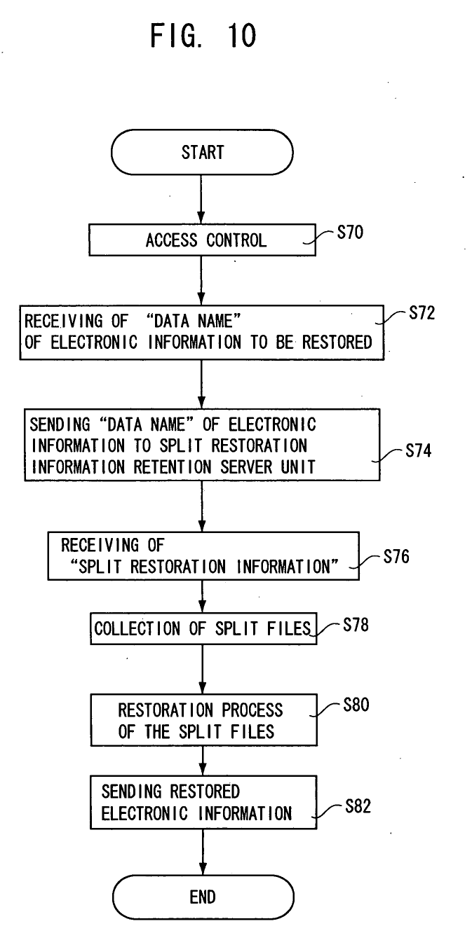

FIG. 10 is a flow chart showing a process flow at the data restoration server unit 12. First, the data restoration server unit 12 examines whether an access is made from the truly authorized front-end server unit 13 to thereby execute access control as necessary (step S70). If it turns out that there is any problem as a result of the access control, processing by the program is suspended.

If there exists no problem with the access control, the data restoration server unit 12 receives the “data name” of electronic information to be restored, from the front-end server unit 13 (step S72). In this case, the “data name” of the electronic information, received from the front-end server unit 13, is temporarily retained in a memory of the controller unit 121, but not retained in the memory unit 125 such as a hard disk, and so forth.

Then, the data restoration server unit 12 sends the data name of the electronic information to be restored to the split restoration information retention server unit 10 via the encrypted communications path L2 (step S74), requesting for retrieval of the “split restoration information”. Thus the data restoration server unit 12 receives the “split restoration information” from the split restoration information retention server unit 10 via the encrypted communication path L2 (step S76).

Subsequently, the data restoration server unit 12 reads the split files from the file storage server units on the basis of the file names of the respective split files, in the split restoration information as received, and the respective names of the storage units, which is the information on the storage destinations, to thereby collect the split files (step S78). On the basis of the “split and conversion rule” in the split restoration information as read, the data restoration server unit 12 applies the split and conversion process in reverse to the split files collected, thereby executing the restoration process of the original electronic information (step S80). In this case, the “split restoration information” received from the split restoration information retention server unit 10, and the electronic information as restored are temporarily retained in a memory of the controller unit 121, but not retained in the memory unit 125 such as a hard disk, and so forth.

Finally, the data restoration server unit 12 sends the original electronic information as restored to the front-end server unit 13 (step S82).

### (7) Split Restoration Information Retention Server Unit

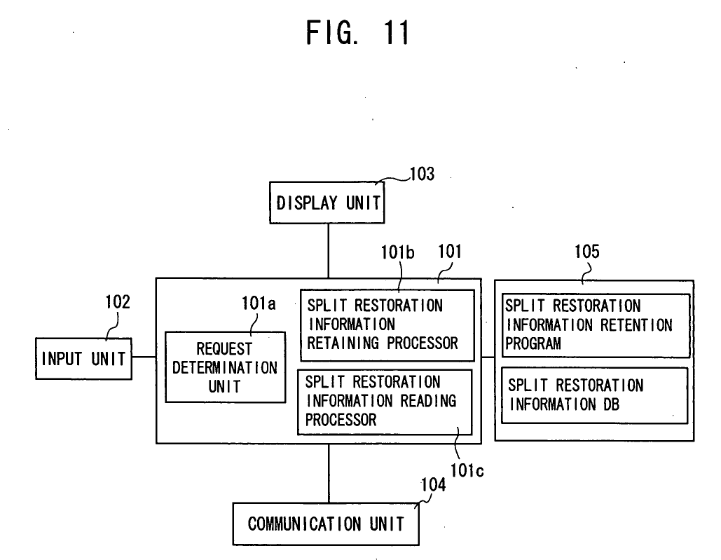

FIG. 11 is a block diagram concerning the split restoration information retention server unit 10. As described above, the split restoration information retention server unit 10 comprises a controller unit 101, an input unit 102, a display unit 103, a communication unit 104, and a memory unit 105. The controller unit 101 consists of a request determination subunit 101a, a split restoration information retaining processor 101b, and a split restoration information reading processor 101c. Respective functions of those parts of the controller unit 101 are implemented by reading the split restoration information retention program in the memory unit 105. Further, split restoration information DB as a database for retaining the split restoration information is stored in the memory unit 105.

The request determination subunit 101a determines whether the request is from the data split server unit 11, or from the data restoration server unit 12. The split restoration information retaining processor 101b stores the split restoration information as received, in the split restoration information DB for processing. The split restoration information reading processor 101c retrieves the split restoration information corresponding to the received “data name” of electronic information before sending the same.

The split restoration information retention server unit 10 communicates only with two server units including the data split server unit 11, and the data restoration server unit 12, using the encrypted communications paths L1 and L2 all the time. The split restoration information retention server unit 10 requires the strictest access control in the system in physical and logical terms.

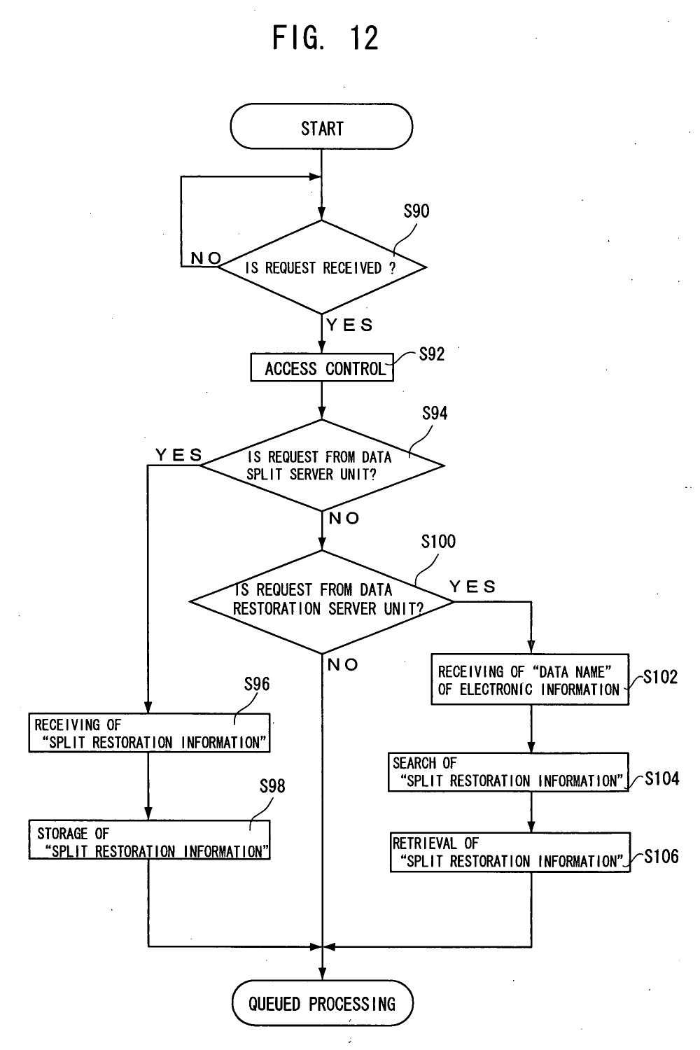

FIG. 12 is a flow chart showing a process flow at the split restoration information retention server unit 10. The split restoration information retention server unit 10 examines whether the request is received from the data split server unit 11 or from the data restoration server unit 12 (step S90), and further examines whether an access is made truly from the authorized data split server unit 11 or from the authorized data restoration server unit 12 when receiving a request, executing access control as necessary (step S92). If it turns out that there is any problem as a result of the access control, processing by the program is suspended.

If there exists no problem with the access control, the split restoration information retention server unit 10 examines whether or not the request is sent from the data split server unit 11 (step S94). If the request is sent from the data split server unit 11, the split restoration information retention server unit 10 receives the split restoration information from the data split server unit 11 via the encrypted communication path L1 (step S96), and stores the split restoration information as received, in the split restoration information DB (step S98).

If it turns out in the step S94 that the request is not sent from the data split server unit 11, the split restoration information retention server unit 10 examines whether the request is sent from the data restoration server unit 12 (step S100). If the request is sent from the data restoration server unit 12, the split restoration information retention server unit 10 receives the “data name” of electronic information from the data restoration server unit 12 via the encrypted communication path L2 (step S102), thereby retrieving the “split restoration information” from the split restoration information DB on the basis of the received “data name” of the electronic information (step S104).

Next, the split restoration information retention server unit 10 sends the “split restoration information” as retrieved to the data restoration server unit 12 (step S106).

### (8) File Storage Server Unit

FIG. 13 is a block diagram concerning the file storage server units 14₁ . . . 14_{N}, and 15₁ . . . 15_{M}. As described above, the file storage server units each comprise a controller unit 141, an input unit 142, a display unit 143, a communication unit 144, and a memory unit 145. The controller unit 141 consists of a file numbers determination subunit 141a, a dummy data generator 141b, and a dummy file generator 141c. Respective functions of those parts of the controller unit 141 are implemented by reading the dummy data generation program stored in the memory unit 145. Further, a file retention folder for storing the split files sent from the data split server unit 11, together with the dummy files, is stored in the memory unit 145.

The file numbers determination subunit 141a monitors the number of files in the file retention folder all the time, thereby determining whether or not the number of the files is not less than a predetermined number. The dummy data generator 141b acquires non-secret information, and applies a reversible data conversion process, and a reversible data split process to the non-secret information, in the same way as in the case of the data split server unit 11, thereby generating a plurality of dummy data blocks. The dummy file generator 141c provides the dummy data blocks generated with file names, respectively, at random, thereby generating dummy files. Because the dummy data blocks, and the dummy files, thus generated, are made in the same way as the split data blocks, and the split files are generated by the data split server unit 11, the former is not distinguishable from the latter.

Upon receiving a split file from the data split server unit 11, the file storage server units each store the split file one by one in the file retention folder thereof. Further, upon receiving a read request from the data restoration server unit 12 by designating file names, the file storage server units each send files corresponding to the file names as designated to the data restoration server unit 12. Such file storage and file read represent the conventional and known process.

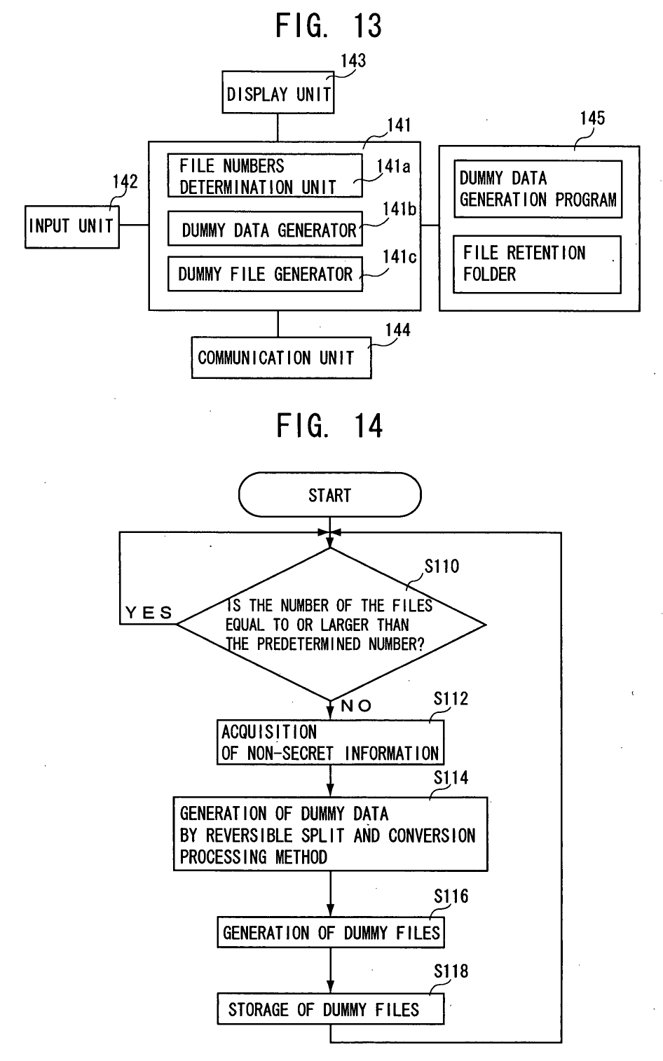

FIG. 14 is a flow chart showing a process flow at the file storage server unit. The file storage server unit examines whether or not the number of the files in the file retention folder is equal to or larger than the predetermined number (for example, 10,000 pieces) (step S110). If the number of the files in the file retention folder is not less than the predetermined number, a similar determination process is repeated periodically or as necessary.

If it is determined in the step S110 that the number of the files is short of the predetermined number, non-secret information is acquired (step S112). The non-secret information is information having no confidentiality, such as data concerning documents and images, disclosed over the Internet. With the use of such significant non-secret information, the dummy data blocks generated can be rendered indistinguishable from the split data blocks generated by the data split server unit 11, and resulting in prevention of restoration of the original electronic information from the files taken out through an unauthorized access.

When an attempt is made to restore the original electronic information through an unauthorized access, it is conceivable that acquisition of a fragment of a bit string, having any significance, is used as an indicator. If the dummy data is generated out of data meaningful to a human being, like genuine electronic information, this can cause a person attempting an unauthorized access to consume energy until completion of restoration of the dummy data.

By applying the same split and conversion processing method as that for the data split server unit 11 to the non-secret information acquired, a plurality of the dummy data blocks are generated (step S114), and file names is generated at random for the respective dummy data blocks to be given thereto, thereby generating dummy files (step S116). Then, the dummy files generated are stored in the file retention folder (step S118), and the process goes back to the step S110, examining whether the number of the files is equal to or larger than the predetermined number. If the number of the files is found still short, more dummy files are generated to be stored.

With the file storage server unit, not less than the predetermined number of the dummy files are generated in advance upon initialization to be then stored in a file retention folder.

Further, if not less than the predetermined number of the dummy files are generated in advance, and when storing the split files, the split files are stored by replacing the dummy files with the same, or by overwriting the dummy files, this will enable the number of the files in the file retention folder to be maintained at not less than the predetermined number, so that a processing step for determining the number of the files, as described above, becomes unnecessary.

Furthermore, the dummy files generated at other units may be stored in the file storage server units. In this case, it is unnecessary to execute processing for generation of the dummy data, so that even a computer of low performance can be used as the file storage server unit. Then, if not less than the predetermined number of the dummy files are stored, and processing is executed such that the split files are stored by substituting for the dummy files, respectively, this will enable not less than the predetermined number of the files to be secured in the file retention folder all the time.

### (9) Makeup of “split Restoration Information”

The “split restoration information” is information wherein the “split and conversion rule”, that is, processing information showing how original electronic information is converted and split, together with the file names of the respective split files, and respective names of storage units, that is, information on storage destinations, are related to the data names, that is, the identification information on the original electronic information.

The “split restoration information” does not contain the original electronic information, and data itself concerning the split files of the original electronic information at all, but contains information necessary for identification of the split files, and information necessary for restoring the original electronic information from the split files, that is to say, the “split restoration information” being something like a treasure map showing where a treasure is found although it is not the treasure itself.

The “split restoration information” is basically a data small in length in a range of tens to hundreds bytes, made up of ASCII characters. Accordingly, the same can be compressed in size approximately to one tenth through common compression algorithm. Owing to smallness in data size, a tight encryption can be applied thereto, so that the “split restoration information” can be rendered to be information with high security, easy to handle.

### (10) Variation 1 to the First Embodiment

With the first embodiment, the front-end program, the data split program, and the data restoration program each are installed in different server units, however, those programs may be combined together appropriately to be installed in the same server unit. By so doing, it is possible to reduce a system construction cost, and a system control cost.

However, the split restoration information retention program should not be installed in any server unit other than the split restoration information retention server unit 10. In contrast to other server units, the split restoration information retention server unit 10 is required to strictly execute access control because the split restoration information retention server unit 10 handles the “split restoration information” which need be kept secret.

Further, the front-end server unit 13, the data split server unit 11, and the data restoration server unit 12 each may be used, doubling as the file storage server unit. In such a case, the dummy data generation program should be installed in those server units doubling as the file storage server unit.

For example, if the data split server unit 11 is caused to have the function of the file storage server unit, the split files can be stored in a file retention folder of the data split server unit 11, thereby speeding up retention processing thereof.

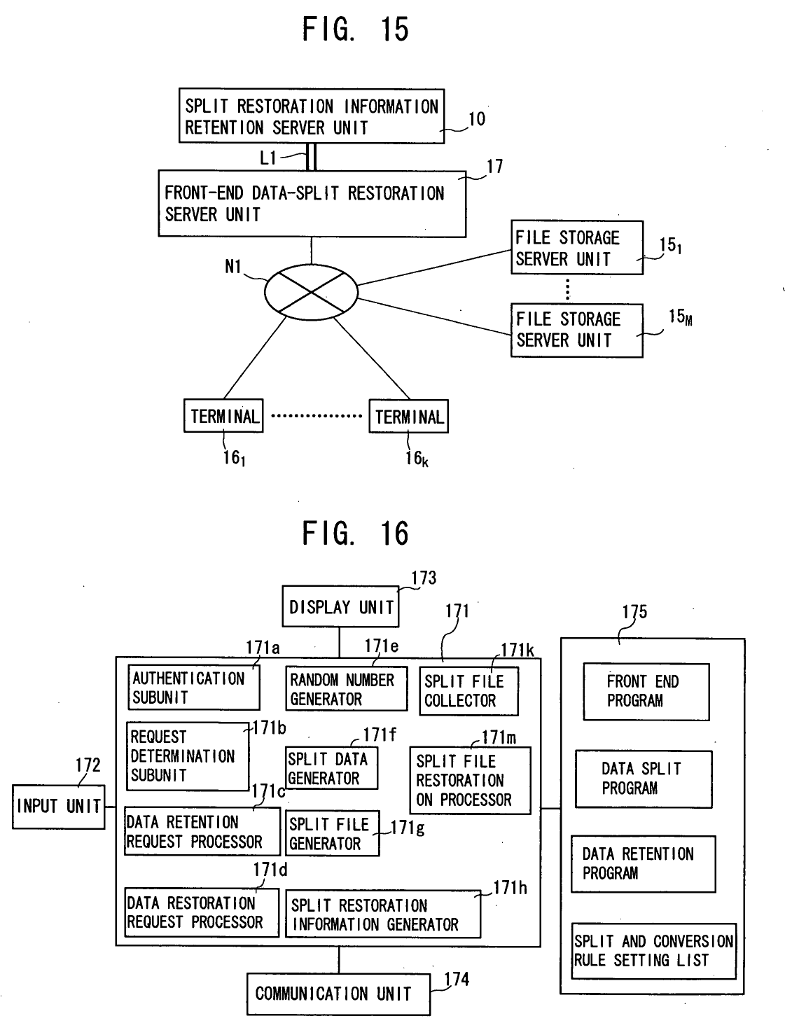

FIG. 15 is a block diagram showing a system configuration wherein the front-end program, the data split program, and the data restoration program are installed in a front-end data-split restoration server unit 17. In comparing this system configuration with the system configuration shown in the FIG. 2, it is shown that the data split server unit 11, the data restoration server unit 12, and the front-end server unit 13 are integrated into one unit of the front-end data-split restoration server unit 17, and as a result, the encrypted communication paths between the front-end data-split restoration server unit 17, and the split restoration information retention server unit 10 are integrated into one length of an encrypted communication path L1, thereby simplifying the present system configuration. Accordingly, a system construction cost, and a system control cost can be reduced.

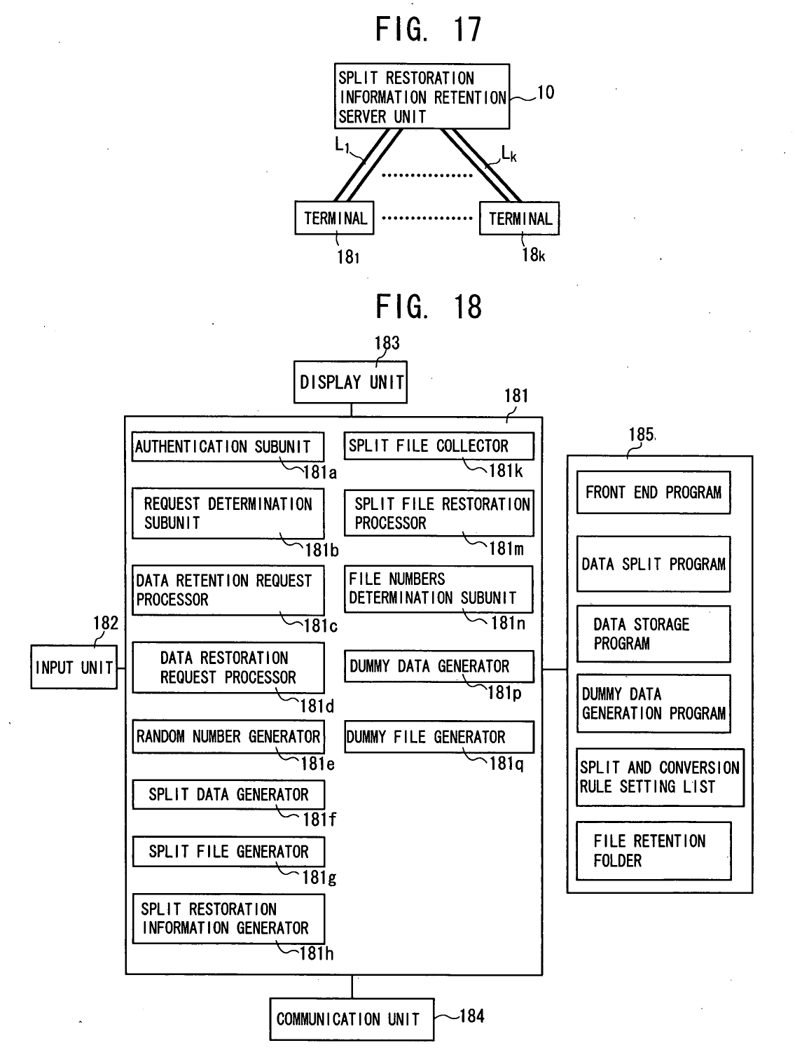

FIG. 16 is a block diagram of the front-end data-split restoration server unit 17. As described above, the front-end data-split restoration server unit 17 comprises a controller unit 171, an input unit 172, a display unit 173, a communication unit 174, and a memory unit 175. The controller unit 171 consists of an authentication subunit 171a, a request determination subunit 171b, a data retention request processor 171c, a data restoration request processor 171d, a random number generator 171e, a split data generator 171f, a split file generator 171g, a split restoration information generator 171h, a split file collector 171k, and a split file restoration processor 171m. Respective functions of those parts of the controller unit 171 are implemented by reading the front-end program, the data split program, and the data restoration program, stored in the memory unit 175, respectively. Furthermore, the split and conversion rule setting list for use in the split and conversion process, and in the restoration process is stored in the memory unit 175.

The process flows for effecting those functions are the same as those for the front-end server unit 13, the data split server unit 11, and the data restoration server unit 12 in the first embodiment, respectively, omitting therefore description thereof.

### (11) Variation 2 to the First Embodiment

The front-end program, the data split program, and the data restoration program may be combined together appropriately to be turned into a single program, provided, however, that only the split restoration information retention program cannot be integrated with other programs into a single program because prevention of leakage of the “split restoration information” is required.

### 2. Second Embodiment

### (1) The Gist of Split and Restoration Process for Electronic Information

A split and restoration process flow for electronic information, according to the second embodiment of the invention, is the same as that shown in FIG. 1, omitting therefore description thereof.

### (2) System Configuration in Whole, and the Gist of Operation

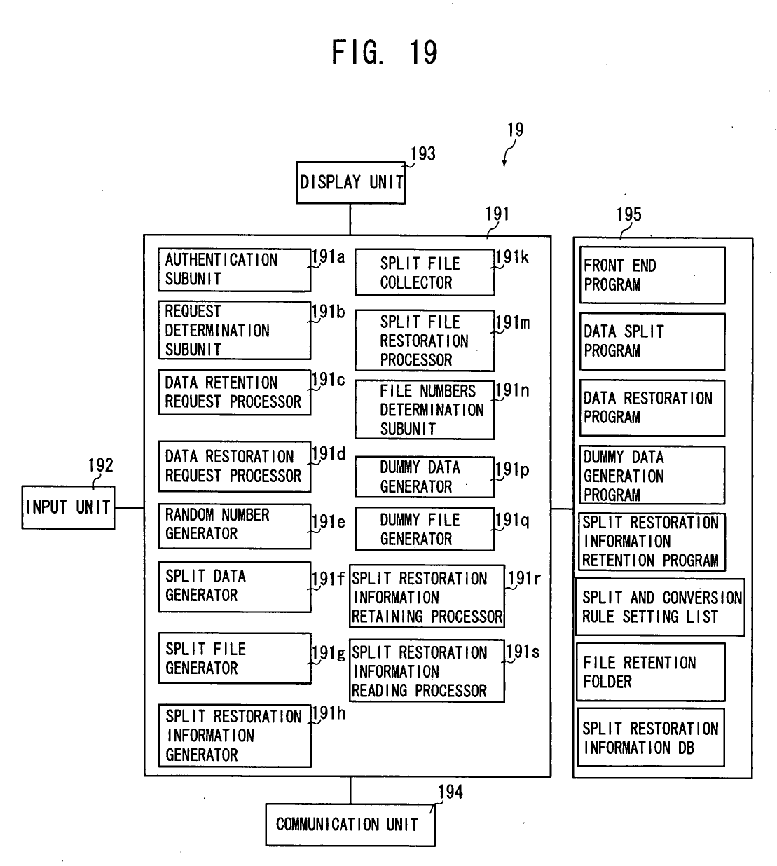

FIG. 17 is a block diagram showing a system configuration according to the second embodiment of the invention. In contrast to the case of the first embodiment, there exists only one unit of split restoration information retention server unit 10 as a server unit, and connection between the split restoration information retention server unit 10, and terminals 18₁ . . . 18ₖ, respectively, is made via encrypted communication paths L₁ . . . Lₖ, respectively, with the use of the LAN if a distance therebetween is short, and with the use of the WAN if the distance is long.

In the figure, the encrypted communication paths L₁ . . . Lₖ are shown as different communication paths between the split restoration information retention server unit 10, and the respective terminals, however, it is meant that those are communication paths different at a logical level, and may be the same communication path in physical terms. Further, it is important that the encrypted communication paths L₁ . . . Lₖ are encrypted, and may be any circuit in physical terms, such as a dedicated line, the Internet, LAN, wireless LAN, and so forth.

In contrast to the terminals 16₁ . . . 16ₖ, the terminals 18₁ . . . 18ₖ each are provided with the front-end program, the data split program, the data restoration program, and the dummy data generation program, installed therein, also having a file retention folder for storing split files, together with dummy files.

In the case of this example, the split restoration information retention program is not installed in the terminals 18₁ . . . 18ₖ, respectively, and by controlling storage and read of the “split restoration information” through single-point concentration thereof, in the split restoration information retention server unit 10, information leakage is prevented, thereby ensuring high security.

With the present embodiment, since the front-end server unit, the data split server unit, the data restoration server unit, and the file storage server units are not used, a system construction cost can be held back.

FIG. 18 is a block diagram concerning the terminals 18₁ . . . 18ₖ. As described above, the respective terminals comprise a controller unit 181, an input unit 182, a display unit 183, a communication unit 184, and a memory unit 185. The controller unit 181 consists of an authentication subunit 181a, a request determination subunit 181b, a data retention request processor 181c, a data restoration request processor 181d, a random number generator 181e, a split data generator 181f, a split file generator 181g, a split restoration information generator 181h, a split file collector 181k, a split file restoration processor 181m, a file numbers determination subunit 181n, a dummy data generator 181p, and a dummy file generator 181q. Respective functions of those parts of the controller unit 181 are implemented by reading the front-end program, the data split program, the data restoration program, and the dummy data generation program, stored in the memory unit 185, respectively. Furthermore, the split and conversion rule setting list for use in the split and conversion process, and the restoration process, and the file retention folder for storing split files, together with dummy files, are stored in the memory unit 185.

The process flows for effecting those functions described are the same as those for the front-end server unit 13, the data split server unit 11, the data restoration server unit 12, and the respective file storage server units, respectively, in the case of the first embodiment, omitting therefore description thereof.

### 3. Third Embodiment

### (1) The Gist of Split and Restoration Process for Electronic Information

A split and restoration process flow for electronic information, according to the third embodiment of the invention, is the same as that shown in FIG. 1 except that the “split restoration information” is encrypted before being stored in the step S16 of the process flow in FIG. 1, omitting therefore description thereof.

### (2) System Configuration in Whole, and the Gist of Operation

With the third embodiment of the invention, the front-end program, the data split program, the data restoration program, the split restoration information retention program, and the dummy data generation program are installed in one information processing unit, for example, a terminal, and no use is made of those server units according to the first embodiment, and the second embodiment, respectively. That is, with the one information processing unit, all the processes can be executed. Accordingly, neither the system construction nor the encrypted communications paths are required, resulting in reduction in communication cost.

In contrast to the case of the second embodiment, the split restoration information retention program as well is installed in the information processing unit. For this reason, according to the split restoration information retention program, the “split restoration information” is encrypted, and stored in the split restoration information DB. That is, because it is very risky to store the “split restoration information” in the same information processing unit that stores split files from the viewpoint of information security, the “split restoration information” is encrypted to be subsequently stored in order to prevent leakage of information.

Since the “split restoration information” is a data relatively small in volume, it is possible to implement encryption very high in security strength although taking time in computation. With the third embodiment, only the “split restoration information”, that is, the data relatively small in volume is encrypted, however, it is possible to obtain an advantageous effect matching that in the case of encrypting all data.

Further, if only the split restoration information DB storing the “split restoration information” is stored in a separate memory, thereby keeping the “split restoration information” separated from the information processing unit proper, this will enhance safety against the unauthorized access

FIG. 19 is a block diagram concerning an information processing unit 19. As is the case with the terminal described above, the information processing unit 19 comprises a controller unit 191, an input unit 192, a display unit 193, a communication unit 194, and a memory unit 195. The controller unit 191 consists of an authentication subunit 191a, a request determination subunit 191b, a data retention request processor 191c, a data restoration request processor 191d, a random number generator 191e, a split data generator 191f, a split file generator 191g, a split restoration information generator 191h, a split file collector 191k, a split file restoration processor 191m, a file numbers determination subunit 191n, a dummy data generator 191p, a dummy file generator 191q, a split restoration information retaining processor 191r, and a split restoration information reading processor 191s.

The split restoration information retaining processor 191r applies an encryption process to the split restoration information generated in the split restoration information generator 191h, thereby storing the same as encrypted split restoration information in the split restoration information DB. The split restoration information reading processor 191s retrieves the encrypted split restoration information corresponding to the “data name” of electronic information as requested to apply a decryption process thereto before outputting decrypted split restoration information to the split file restoration processor 191m.

Respective functions of those parts of the controller unit 191 are implemented by reading the front-end program, the data split program, the data restoration program, the dummy data generation program, and the split restoration information retention program, stored in the memory unit 195, respectively. Furthermore, the split and conversion rule setting list for use in the split and conversion process, and the restoration process, the file retention folder for storing split files, together with dummy files, and the split restoration information DB for storing the split restoration information are stored in the memory unit 195.

The process flows for effecting those functions described are the same as those for the front-end server unit 13, the data split server unit 11, the data restoration server unit 12, and the respective file storage server units, respectively, in the case of the first embodiment, and are also the same as that for the split restoration information retention server unit 10 except that when the split restoration information is storing in the step S98 of the flow shown in FIG. 12, the encryption process is applied thereto so as to be storing as the encrypted split restoration information while the decryption process is applied to the encrypted split restoration information retrieved in the step S104, omitting therefore description of the processes other than that.

### 4. Fourth Embodiment

### (1) The Gist of Split and Restoration Process for Electronic Information

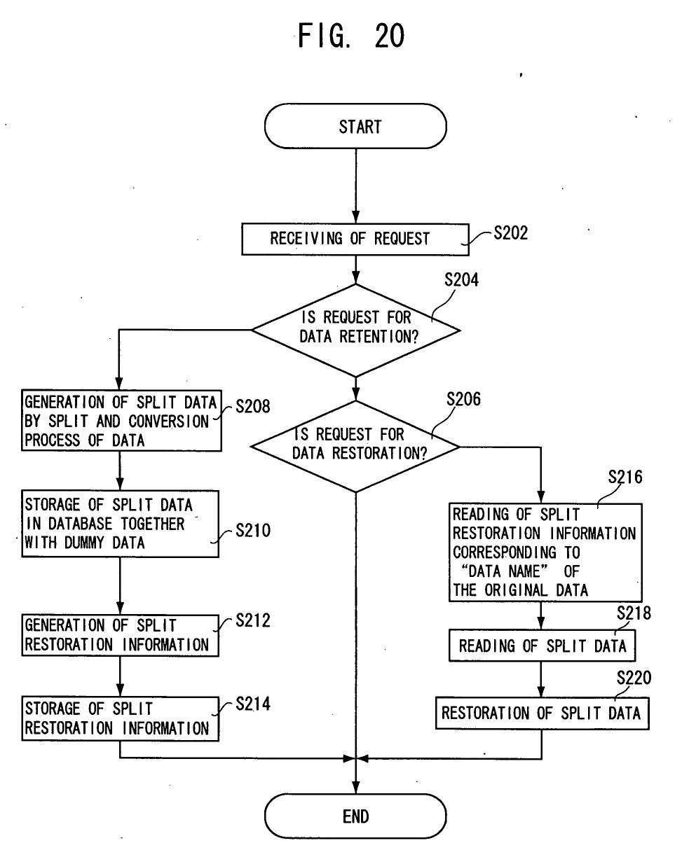

FIG. 20 is a flow chart showing a split and restoration process flow for electronic information, according to the fourth embodiment of the invention. The split and restoration processing for electronic information is substantially the same as that shown in FIG. 1, but differs in that the split data blocks generated by the split and conversion process, together with dummy data, are stored in a database. Accordingly, description on the steps of the flow, identical in content to those in FIG. 1, is omitted, and there are described points centering around storage in the database.

The split and restoration process for electronic information is started upon the front-end program receiving a request for processing (step S202). The front-end program first checks an access right of a request sender, and if the request sender does not have the access right, the request is rejected. There is shown the process hereinafter if the access right exists.

If the request is a request for data retention (step S204), the front-end program runs a process for delivering electronic information to the data split program.

The data split program generates split data blocks by applying a reversible split and conversion process to electronic information intended for retention (step S208). The split and conversion process is selected at random among a multitude of reversible data conversion processes, and reversible data split processes, and parameters involved in processing are also generated at random. By so doing, it becomes difficult for anyone to surmise the split and conversion process applied to the electronic information.

Next, the split data blocks generated, together with dummy data, are stored in the database (step S210). The dummy data is a data that is the same in kind as the split data blocks, and cannot be distinguished from the latter on the basis of data content, data size, and so forth. For example, if the split data blocks each are made up of a meaningless data row, the dummy data as well have a data row, which is similarly a meaningless data row. The dummy data can be generated through rearrangement of the data row of non-secret information, or by use of random numbers, but it need only be sufficient to generate the dummy data by applying the reversible data conversion process, and reversible data split process to non-secret information as is the case with the split data blocks.

Upon completion of the storage of the split data blocks, the data split program generates the “split restoration information” for relating the “split and conversion rule”, that is, the processing information showing how original electronic information is converted and split, together with information on storage locations of the respective split data blocks, in a database, and information on storage destinations of the respective split data blocks (database names, and respective names of storage units), to data names, that is, identification information on the original electronic information (step S212), thereby sending the “split restoration information” to the split restoration information retention program via the encrypted communication paths. According to the split restoration information retention program, the “split restoration information” is stored in files or databases (step S214). The above completes the split and retention process of the electronic information.

Next, if a request received by the front-end program is a request for data restoration (step S206), the front-end program reads a “data name” of electronic information under request, sending the same to the data restoration program.

The data restoration program sends the “data name” of the electronic information to the split restoration information retention program via the encrypted communication paths. The split restoration information retention program reads the “split restoration information” corresponding to the “data name”, sending the same to the data restoration program (step S216).

The data restoration program reads, and collect the split data blocks from the database on the basis of the information on the storage locations of the respective split data blocks, and the information on the storage destinations of the respective split data blocks, in the “split restoration information” as transmitted (step S218), executing processing by reversely applying the “split and conversion rule” in the “split restoration information” to thereby restore the original electronic information (step S220). Since the data conversion process and the data split process, specified in the “split and conversion rule”, are all reversible, the restoration process can be accurately executed all the time.

The data restoration program sends the electronic information as restored to the front-end program, and the front-end program transmits the electronic information as received to the request sender. By so doing, the restoration process for the electronic information split and retained is completed.

### (2) System Configuration in Whole

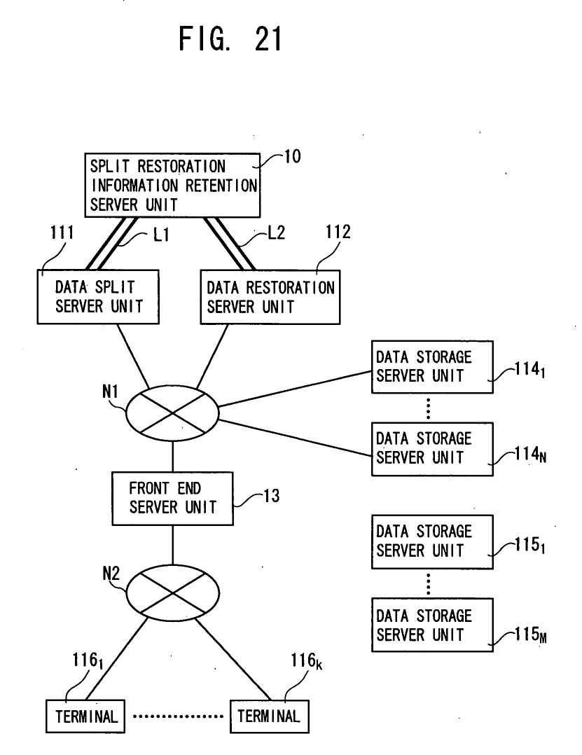

FIG. 21 is a block diagram showing a system configuration in whole, according to the fourth embodiment of the invention. In the figure, units identical to those in the block diagram of the system configuration in whole, shown in FIG. 2, are denoted by like reference numerals, omitting duplication in description.

The data restoration program is installed in a data restoration server unit 112. Upon the data restoration server unit 112 receiving a “data name” of electronic information from a front-end server unit 13, the data restoration server unit 112 sends the “data name” of the electronic information to a split restoration information retention server unit 10 via an encrypted communication path L2. The split restoration information retention server unit 10 reads the “split restoration information” corresponding to the “data name” of the electronic information, as received, and sends the “split restoration information” as read to the data restoration server unit 112 via the encrypted communication path L2.

Next, the data restoration server unit 112 reads split data blocks from data storage server units 114₁ . . . 114_{N}, and 115₁ . . . 115_{M}, respectively, on the basis of the information on the storage locations of the respective split data blocks, and the information on the storage destinations of the respective split data blocks, in the “split restoration information”, thereby restoring the original electronic information by processing through reverse application of the “split and conversion rule” in the “split restoration information”. Then, the data restoration server unit 112 sends the electronic information as restored to the front-end server unit 13.

The front-end server unit 13 sends the electronic information received from the data restoration server unit 112 to the terminal of the request sender to thereby enable the request sender to read and process the electronic information on the terminal.

If the request is a request for data retention, electronic information to be retained is sent from the terminal, and the front-end server unit 13 sends the electronic information as received to a data split server unit 111.

The data split program is installed in the data split server unit 111. Upon the data split server unit 111 receiving electronic information from the front-end server unit 13, the data split server unit 111 applies a reversible data conversion process, and a reversible data split process to the electronic information to be retained, thereby generating a plurality of split data blocks, and storing the split data blocks in databases in the data storage server units 14₁ . . . 14_{N}, and 15₁ . . . 15_{M}, respectively. At which storage locations in the databases of the respective data retention server units there are to be stored the respective split data blocks is decided upon by use of random numbers so as not to cause the storage locations to overlap each other.

The data storage server units 114₁ . . . 114_{N}, and 115₁ . . . 115_{M} each are units for storing the split data blocks, together with the dummy data, in the database, and the dummy data generation program, and a database management program are installed therein. Dummy data indistinguishable from the split data blocks are generated by the dummy data generation program, and when the split data blocks are stored, the dummy data is generated and stored such that the number of data blocks retained in the database is not less than the predetermined number all the time. Furthermore, fast storage and read of the split data blocks as well as the dummy data can be executed by the database management program. As a result of the split data blocks and the dummy data being stored in the database, the number itself of the data blocks cannot be easily estimated from outside.

Upon the completion of the storage of the split data blocks, the data split server unit 111 generates the “split restoration information” concerning the electronic information processed, that is, information wherein the “split and conversion rule”, that is, the processing information showing how original electronic information is converted and split, together with the information on the storage locations of the respective split data blocks, in the database, and the information on the storage destinations of the respective split data blocks (the database names, and respective names of the storage units) are related to the data names, that is, the identification information on the original electronic information. The “split restoration information” as generated is sent to the split restoration information retention server unit 10 via the encrypted communication path L1.

Upon receipt of the “data name” of the electronic information from the data restoration server unit 112 via the encrypted communication path L2, the split restoration information retention server unit 10 reads the “split restoration information” corresponding to the “data name” of the electronic information received, thereby sending the “split restoration information” to the data restoration server unit 112. Further, the split restoration information retention server unit 10 stores the “split restoration information” received from the data split server unit 111 via the encrypted communication path L1, in files or databases.

### (3) Data Split Server Unit

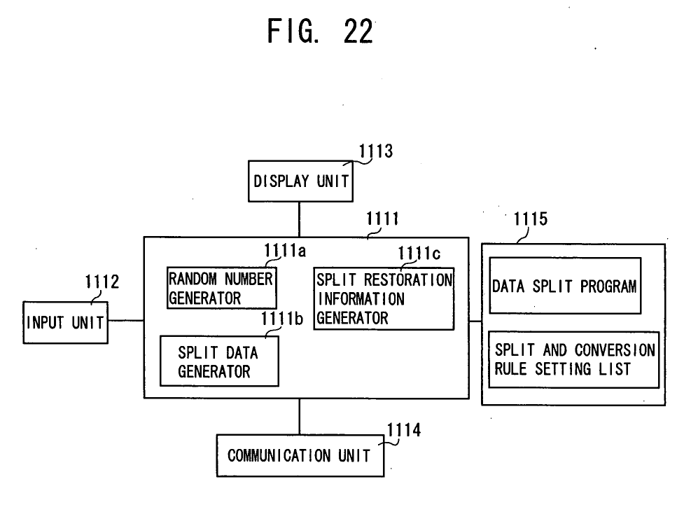

FIG. 22 is a block diagram concerning the data split server unit 111. The data split server unit 111 comprises a controller unit 1111, an input unit 1112, a display unit 1113, a communication unit 1114, and a memory unit 1115. The controller unit 1111 consists of a random number generator 1111a, a split data generator 1111b, and a split restoration information generator 1111c. Respective functions of those parts of the controller unit 1111 are implemented by reading the data split program stored in the memory unit 1115. Further, the split and conversion rule setting list for use in generation of the split data blocks is stored in the memory unit 1115.

The random number generator 1111a generates random numbers in the case of selecting the data conversion process, and the data split process at random upon generation of the split and conversion rule for generation of the split data blocks, in the case of providing at random the split data with respective storage locations of the split data blocks in the database, and in the case of selecting respective storage destinations of the split data blocks at random.

The split data generator 111b generates the split and conversion rule by selecting a reversible data conversion process, and data split process at random, and executes processing of electronic information to be retained on the basis of the split and conversion rule, thereby generating a plurality of the split data blocks. The split and conversion process is the same as that for the first embodiment. And the respective storage locations in the database, for storing the split data blocks, are provided at random, and the storage destinations thereof are selected at random.

The split restoration information generator 1111c relates the split and conversion rule used in the split data generator 1111b, together with information on the storage locations of the split data blocks, and information on storage destinations thereof, to the “data name” of the electronic information received from the front-end server unit 13, thereby generating the split restoration information.

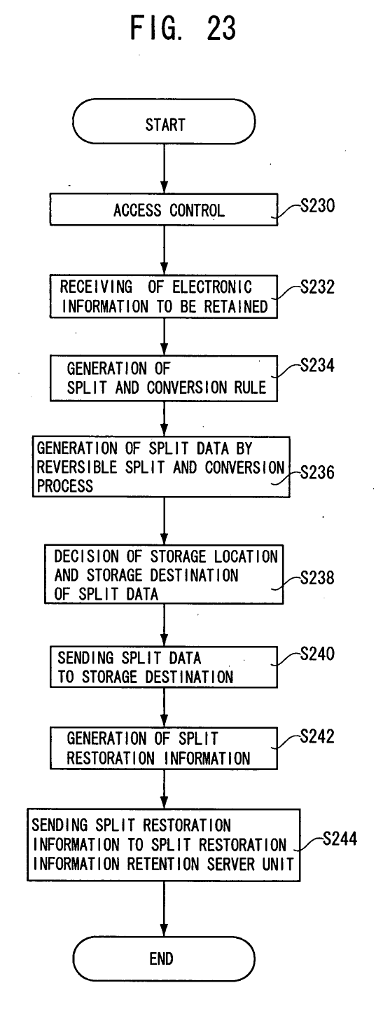

FIG. 23 is a flow chart showing a process flow at the data split server unit 111. First, the data split server unit 111 examines whether an access is made from a truly authorized front-end server unit 13 to thereby execute access control as necessary (step S230). If it turns out that there is any problem as a result of the access control, processing by the program is suspended.

If there exists no problem with the access control, the data split server unit 111 receives electronic information to be retained, from the front-end server unit 13 (step S232). In this case, the electronic information received from terminals is temporarily stored in a memory of the controller unit 1111, but not stored in the memory unit 1115 such as a hard disk, and so forth.

Next, the data split server unit 111 selects a reversible data conversion process, and data split process at random by use of the split and conversion rule setting list stored in the memory unit 1115, thereby generating a split and conversion rule (step S234). Then, processing is applied to the electronic information to be retained, on the basis of the split and conversion rule, thereby generating a plurality of split data blocks (step S236). Processing to be executed in the steps S234, and S236, respectively, is the same as that for the first embodiment.

Subsequently, each of the plurality of the split data blocks generated by the split and conversion process is provided with a storage location in the database at random. Respective storage destinations of the split data blocks are decided upon through selection thereof at random from among the respective databases of the data storage server units, preset as information on the storage destinations (step S238). In this case, the electronic information received from the terminals is temporarily retained in the memory of the controller 1111, but not stored in the memory unit 1115 such as the hard disk, and so forth.

Then, a plurality of the split data blocks generated are sent to the data storage server units as decided, respectively, to be processed for storage in the databases (step S240).

Next, the “split restoration information” is generated (step S242), wherein “the split and conversion rule” which is the processing information concerning the split and conversion process, generated in the step S234, together with the storage locations of the respective split data blocks, and information on the respective storage destinations of the split data blocks decided in the step 238, is related to the “data names” of the original electronic information. The “split restoration information” as generated is sent to the split restoration information retention server unit 10 via the encrypted communication path L1 (step S244).

### (4) Data Restoration Server Unit

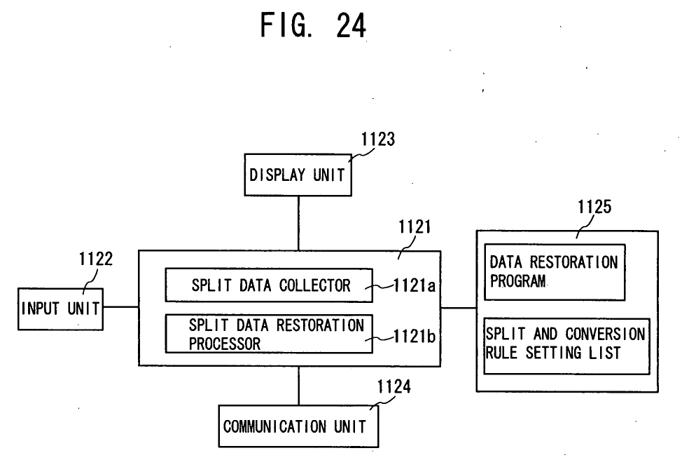

FIG. 24 is a block diagram concerning a data restoration server unit 112. The data restoration server unit 112 comprises a controller unit 1121, an input unit 1122, a display unit 1123, a communication

unit 1124, and a memory unit 1125. The controller unit 1121 consists of a split data block collector 1121a, and a split data block restoration processor 1121b. Respective functions of those parts of the controller unit 1121 are implemented by reading the data restoration program stored in the memory unit 1125. Further, the split and conversion rule setting list for use in the restoration process of the split data blocks is stored in the memory unit 1125.

The split data collector 1121a reads the split data blocks from the data storage server units on the basis of the information on the storage locations of the respective split data blocks, and the information on the storage destinations of the respective split data blocks (database names, and respective names of storage units), contained in the split restoration information as read, thereby collecting the split data blocks. On the basis of the “split and conversion rule” in the split restoration information as read, the split data block restoration processor 1121b applies the split and conversion process in reverse to the split data blocks collected, thereby executing the restoration process of the original electronic information.

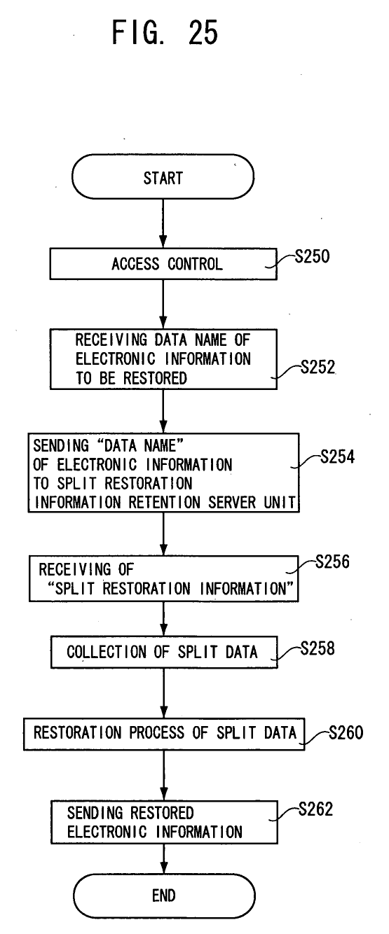

FIG. 25 is a flow chart showing a process flow at the data restoration server unit 112. First, the data restoration server unit 112 examines whether an access is made from a truly authorized front-end server unit 13 to thereby execute access control as necessary (step S250). If it turns out that there is any problem as a result of the access control, processing by the program is suspended.

If there exists no problem with the access control, the data restoration server unit 112 receives the “data name” of electronic information to be restored, from the front-end server unit 13 (step S252). In this case, the “data name” of the electronic information, received from the front-end server unit 13, is temporarily retained in a memory of the controller unit 1121, but not stored in the memory unit 1125 such as a hard disk, and so forth.

Then, the data restoration server unit 112 sends the “data name” of the electronic information to be restored to the split restoration information retention server unit 10 via the encrypted communication path L2 (step S254), requesting for retrieval of the “split restoration information”. And the data restoration server unit 112 receives the “split restoration information” from the split restoration information retention server unit 10 via the encrypted communication path L2 (step S256).

Subsequently, the data restoration server unit 112 reads the split data blocks from the data storage server units on the basis of the information on the storage locations of the respective split data blocks, and the information on the storage destinations of the respective split data blocks, contained in the split restoration information as received, thereby collecting the split data blocks (step S258). On the basis of the “split and conversion rule” in the split restoration information as read, the data restoration server unit 112 applies the split and conversion process in reverse to the split data blocks collected, thereby executing the restoration process of the original electronic information (step S260). In this case, the “split restoration information” received from the split restoration information retention server unit 10, and the electronic information as restored are temporarily retained in the memory of the controller unit 1121, but not stored in the memory unit 1125 such as the hard disk, and so forth.

Finally, the data restoration server unit 112 sends the original electronic information as restored to the front-end server unit 13 (step S262).

### (5) Data Storage Server Unit

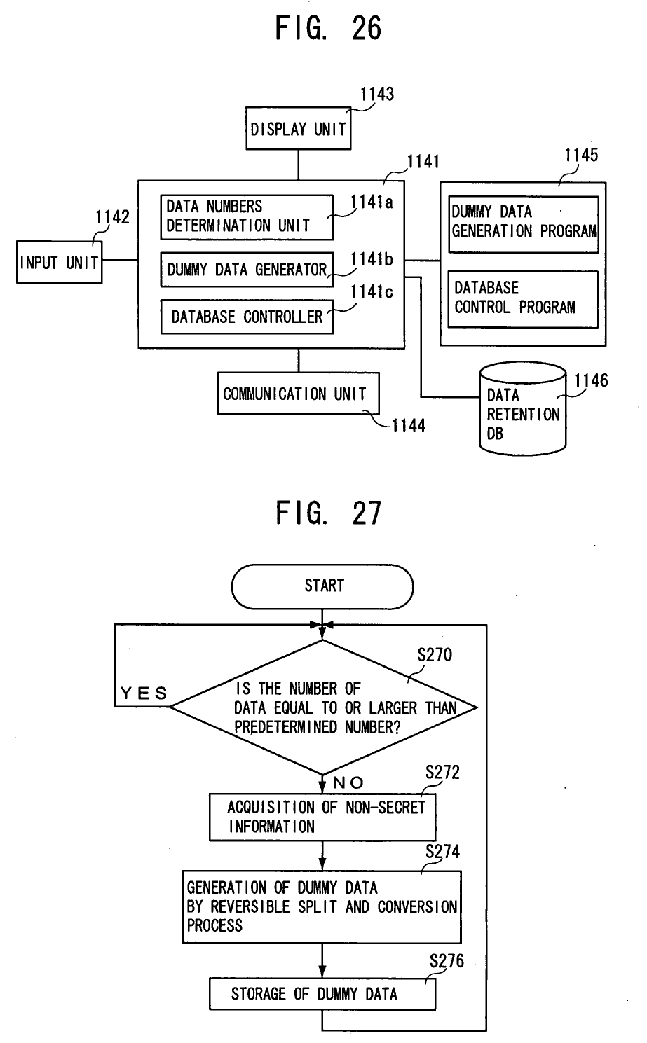

FIG. 26 is a block diagram concerning the data storage server units 114₁ . . . 114_{N}, and 115₁ . . . 115_{M}. The data storage server units each comprise a controller unit 1141, an input unit 1142, a display unit 1143, a communication unit 1144, a memory unit 1145 and a data retention DB 1146. The controller unit 1141 consists of a data numbers determination subunit 1141a, a dummy data generator 1141b, and a database controller 1141c. Respective functions of those parts of the controller 1141 are implemented by reading the dummy data generation program, and the database management program, stored in the memory unit 1145.

The data numbers determination unit 1141a monitors the number of data blocks stored in the data retention DB 1146 all the time, thereby determining whether or not the number of the data blocks is equal to or larger than the predetermined number. The dummy data generator 1141b acquires non-secret information, and applies the same reversible data conversion process, and reversible data split process as those in the case of the data split server unit 111 to the non-secret information, thereby generating a plurality of dummy data blocks. Because the dummy data blocks, thus generated, are generated in the same way as the split data blocks generated by the data split server unit 111, the former is not distinguishable from the latter. The database controller 1141c stores the split data blocks and the dummy data blocks at designated storage locations in the data retention DB 1146, and reads the respective split data blocks at the designated storage locations in response to a request for read of the split data blocks.

FIG. 27 is a flow chart showing a process flow at the data storage server unit. The data storage server unit examines whether or not the number of the data blocks stored in the data retention DB 1146 is equal to or larger than the predetermined number (for example, 10,000 pieces) (step S270). If the number of the data blocks is not less than the predetermined number, a similar determination process is repeated periodically or as necessary.

If it is determined in the step S270 that the number of the data blocks is short of the predetermined number, non-secret information is acquired (step S272). The non-secret information is information having no confidentiality, such as, data concerning documents and images, disclosed over the Internet. With the use of such significant non-secret information, the dummy data blocks generated can be rendered indistinguishable from the split data blocks generated by the data split server unit 111, resulting in prevention of restoration of the original electronic information from the files taken out through an unauthorized access.

When an attempt is made to restore the original electronic information through an unauthorized access, it is conceivable that acquisition of a fragment of a bit string, having any significance, is used as an indicator, however, if the dummy data is generated out of data meaningful to a human being, like genuine electronic information, this can cause a person attempting an unauthorized access to consume energy until completion of restoration of the dummy data.

By applying the same split and conversion processing method as that for the data split server unit 111 to the non-secret information acquired, a plurality of the dummy data blocks are generated (step S274). The dummy data blocks as generated are stored at respective storage locations in the data retention DB 1146, selected at random (step S276). Then, the process goes back to the step S270, examining whether the number of the data blocks is equal to or larger than the predetermined number. If the number of the data blocks is found still short, the dummy data blocks are further generated to be stored.

Further, with the data storage server unit, not less than the predetermined number of the dummy data blocks are generated in advance upon initialization to be stored in the data retention DB 1146.

Further, if not less than the predetermined number of the dummy data blocks are generated in advance, and when storing the split data blocks, the split data blocks are stored by replacing the dummy data blocks with the same, or by overwriting the dummy data blocks, this will enable the number of the data blocks stored in the data retention DB 1146 to be maintained at not less than the predetermined number, so that a processing step for determining the number of the data blocks, described as above, becomes unnecessary.

Furthermore, the dummy data blocks generated at other units may be stored in the data storage server units. In this case, it becomes unnecessary to execute processing for generation of the dummy data blocks, so that even a computer of low performance can be used as the data storage server unit. Then, if not less than the predetermined number of the dummy data blocks are stored, and when storing the split data blocks, processing is executed such that the split data blocks are stored by replacing the dummy data blocks with the same, respectively, this will enable not less than the predetermined number of the data blocks to be secured in the data retention DB 1146 all the time.

Server units other than those server units described in the foregoing are the same as those corresponding thereto in the first embodiment, omitting therefore description thereof.

Thus, even if split data blocks generated in the same way as is the case with the first embodiment, together with the dummy data blocks indistinguishable from the split data blocks, are stored in the database, it will be extremely difficult to identify the split data blocks in the same way as in the first embodiment, so that it becomes extremely difficult to restore electronic information from the split data blocks. Further, in the case of storing the split data blocks in the database, it is possible to retrieve the same at a high speed as compared with the case of storing the same as the split files, thereby enhancing a processing speed. Furthermore, if respective data blocks are hierarchically stored in the database, this will render it difficult to easily find out the number of the data blocks stored, thereby ensuring still higher confidentiality.

### 5. Fifth Embodiment

### (1) The Gist of Split and Restoration Process for Electronic Information

A split and restoration process flow for electronic information, according to the fifth embodiment of the invention, is the same as that shown in FIG. 20, omitting therefore description thereof.

### (2) System Configuration in Whole, and the Gist of Operation

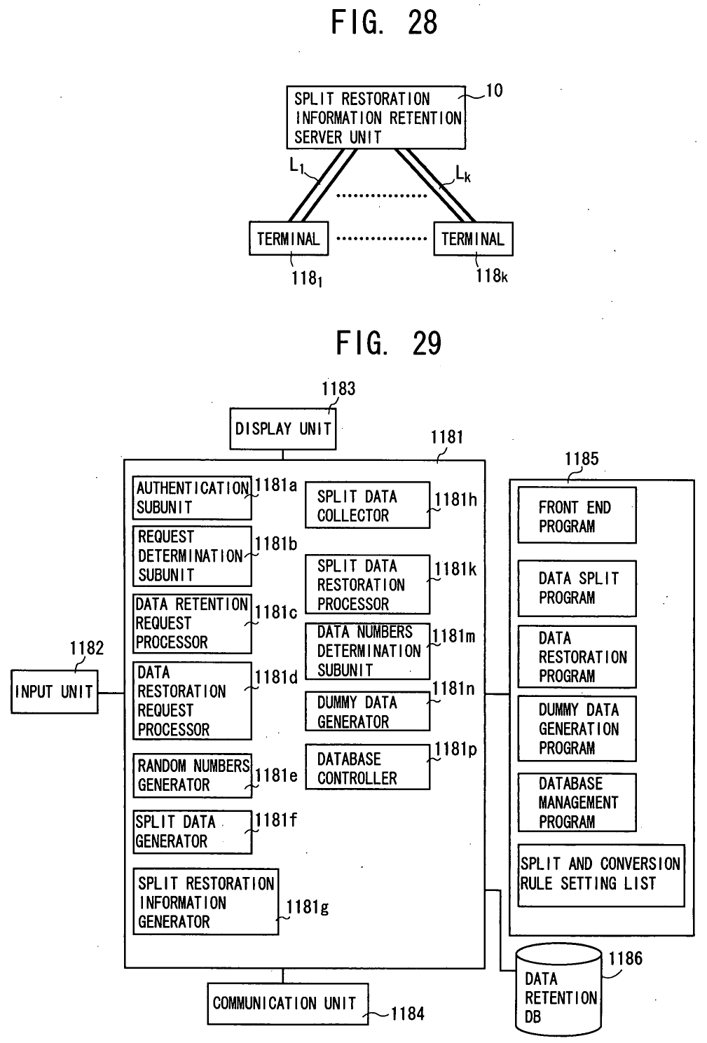

FIG. 28 is a block diagram showing a system configuration according to the fifth embodiment of the invention. In contrast to the case of the fourth embodiment, there exists only one unit of split restoration information retention server unit 10 as a server unit, and connection between the split restoration information retention server unit 10, and terminals 118₁ . . . 118ₖ, respectively, is made via encrypted communication paths L₁ . . . Lₖ, respectively, with the use of the LAN if a distance therebetween is short, and with the use of the WAN if the distance is long. A system configuration in whole is the same as that shown in FIG. 17.

In contrast to terminals the 116₁ . . . 116ₖ, as shown in FIG. 21, the terminals 118₁ . . . 118ₖ each have the front-end program, the data split program, the data restoration program, the dummy data generation program, and the database management program, installed therein, further having a data retention DB 1186 for storing split data blocks together with the dummy data blocks.

FIG. 29 is a block diagram concerning the terminals 118₁ . . . 118ₖ. The respective terminals comprise a controller unit 1181, an input unit 1182, a display unit 1183, a communication unit 1184, a memory unit 1185 and the data retention DB 1186. The controller 1181 consists of an authentication sub-unit 1181a, a request determination sub-unit 1181b, a data retention request processor 1181c, a data restoration request processor 1181d, a random number generator 1181e, a split data generator 1181f, a split restoration information generator 1181g, a split data collector 1181h, a split data restoration processor 1181k, a data numbers determination subunit 1181m, a dummy data generator 1181n, and a database controller 1181p. Respective functions of those parts of the controller unit 1181 are implemented by reading the front-end program, the data split program, the data restoration program, the dummy data generation program, and the database management program, stored in the memory unit 1185, respectively. Furthermore, the split and conversion rule setting list for use in the split and conversion process, and the restoration process is stored in the memory unit 1185.

Respective process flows for those functions are the same as those for the front-end server unit 13 according to the first embodiment, and the data split server unit 111 together with the data restoration server unit 112, and the respective data storage server units, in the case of the fourth embodiment, respectively, omitting therefore description thereof.

### 6. Sixth Embodiment

### (1) The Gist of Split and Restoration Process for Electronic Information

A split and restoration process flow for electronic information, according to the sixth embodiment of the invention, is the same as that shown in FIG. 20, except that the split restoration information is encrypted in the step S214 before being stored, omitting therefore description thereof.

### (2) System Configuration in Whole, and the Gist of Operation

With the sixth embodiment, the front-end program, the data split program, the data restoration program, the split restoration information retention program, the dummy data generation program, and the database management program are installed in one information processing unit, for example, a terminal, and no use is made of those server units that are in use in the case of the fourth and fifth embodiments, respectively. That is, with the one information processing unit, all the processes can be executed. Accordingly, neither the system construction nor the encrypted communication paths are required, resulting in reduction in communication cost.

In contrast to the case of the fifth embodiment, the split restoration information retention program as well is installed in the information processing unit. For this reason, according to the split restoration information retention program, the “split restoration information” is encrypted before being stored in a split restoration information DB. That is, because it is very risky in terms of information security to store the “split restoration information” in the same information processing unit that stores split files, the “split restoration information” is encrypted to be subsequently stored in order to prevent information leakage.

Since the “split restoration information” is a data relatively small in volume, it is possible to implement encryption very high in security strength, although taking time in computation. With the sixth embodiment, only the “split restoration information”, that is, the data relatively small in volume is encrypted, however, it is possible to obtain an advantageous effect matching that in the case of encrypting all data.

Further, if only the split restoration information DB storing the “split restoration information” is stored in a separate memory, thereby keeping the “split restoration information” separated from the information processing unit, this will enhance safety against the unauthorized access.

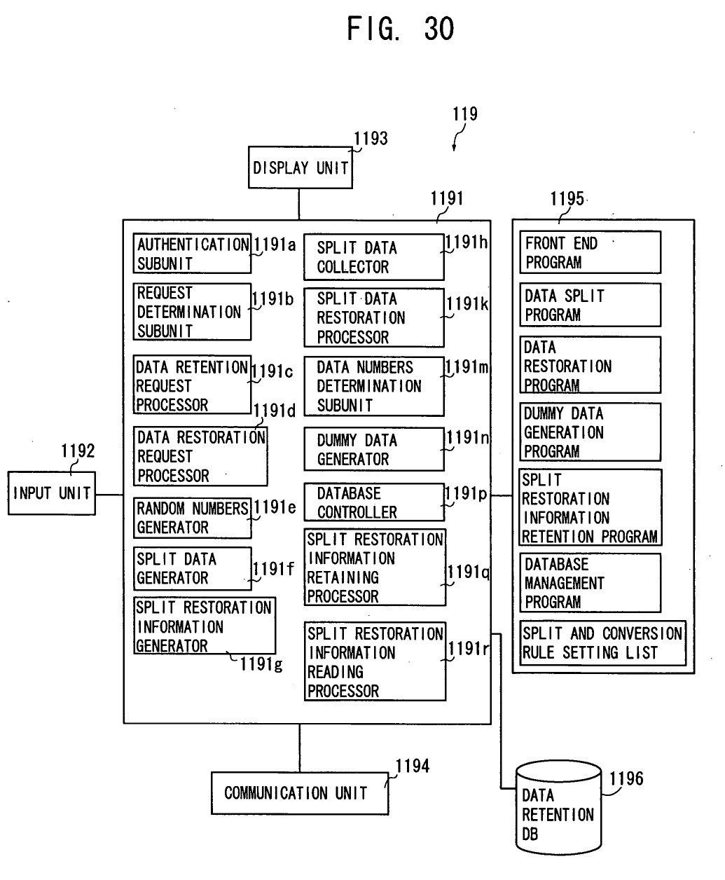

FIG. 30 is a block diagram concerning an information processing unit 119. As is the case with the terminal described as above, the information processing unit 119 comprises a controller unit 1191, an input unit 1192, a display unit 1193, a communication unit 1194, a memory unit 1195, and a data retention DB 1196. The controller unit 1191 consists of an authentication subunit 1191a, a request determination subunit 1191b, a data retention request processor 1191c, a data restoration request processor 1191d, a random number generator 1191e, a split data generator 1191f, a split restoration information generator 1191g, a split data collector 1191h, a split data restoration processor 1191k, a data numbers determination subunit 1191m, a dummy data generator 1191n, a database controller 1191p, a split restoration information retaining processor 1191q, and a split restoration information reading processor 1191r. The split restoration information retaining processor 1191q applies an encryption process to the split restoration information generated in the split restoration information generator 1191g, thereby storing the same as encrypted split restoration information in the split restoration information DB. The split restoration information reading processor 1191r retrieves the encrypted split restoration information corresponding to the “data name” of electronic information as requested to apply a decryption process thereto before outputting decrypted split restoration information to the split data restoration processor 1191k.

Respective functions of those parts of the controller unit 1191 are implemented by reading the front-end program, the data split program, the data restoration program, the dummy data generation program, the split restoration information retention program, and the database management program, stored in the memory unit 1195, respectively. Furthermore, the split and conversion rule setting list for use in the split and conversion process, and the restoration process, and the split restoration information DB for storing the split restoration information are stored in the memory unit 1195.

The process flows for effecting those functions described are the same as those for the front-end server unit 13 according to the first embodiment, and the data split server unit 111 together with the data restoration server unit 112, and the respective data storage server units, in the case of the fourth embodiment, respectively, and also, are the same as that for the split restoration information retention server unit 10 except that when the split restoration information is stored in the step S98 of the flow shown in FIG. 12, the encryption process is applied thereto so as to be stored as the encrypted split restoration information while the decryption process is applied to the encrypted split restoration information retrieved in the step S104, omitting therefore description of the processes other than that.

### BRIEF DESCRIPTION OF THE INVENTION

FIG. 1 is a flow chart showing a split and restoration process flow for electronic information, according to the first embodiment of the invention;

FIG. 2 is a block diagram showing a system configuration according to the first embodiment of the invention;

FIG. 3 is a block diagram concerning the first embodiment of the invention;

FIG. 4 is a block diagram showing a hardware makeup concerning the first embodiment of the invention;

FIG. 5 is a block diagram concerning a front-end server unit;

FIG. 6 is a flow chart showing a process flow at the front-end server unit;

FIG. 7 is a block diagram concerning a data split server unit;

FIG. 8 is a flow chart showing a process flow at the data split server unit;

FIG. 9 is a block diagram concerning a data restoration server unit;

FIG. 10 is a flow chart showing a process flow at the data restoration server unit;

FIG. 11 is a block diagram concerning a split restoration information retention server unit;

FIG. 12 is a flow chart showing a process flow at the split restoration information retention server unit;

FIG. 13 is a block diagram concerning a file storage server unit;

FIG. 14 is a flow chart showing a process flow at the file storage server unit;

FIG. 15 is a block diagram showing a system configuration according to a variation to the first embodiment;

FIG. 16 is a block diagram concerning a front-end data-split restoration server unit according to the variation;

FIG. 17 is a block diagram showing a system configuration according to the second embodiment of the invention;

FIG. 18 is a block diagram concerning a terminal according to the second embodiment of the invention;

FIG. 19 is a block diagram concerning an information processing unit according to the third embodiment of the invention;

FIG. 20 is a flow chart showing a split and restoration process flow for electronic information, according to the fourth embodiment of the invention;

FIG. 21 is a block diagram showing a system configuration in whole, according to the fourth embodiment of the invention;

FIG. 22 is a block diagram concerning a data split server unit according to the fourth embodiment of the invention;

FIG. 23 is a flow chart showing a process flow at the data split server unit;

FIG. 24 is a block diagram concerning a data restoration server unit;

FIG. 25 is a flow chart showing a process flow at the data restoration server unit;

FIG. 26 is a block diagram concerning a data storage server unit;

FIG. 27 is a flow chart showing a process flow at the data storage server unit;

FIG. 28 is a block diagram showing a system configuration according to the fifth embodiment of the invention;

FIG. 29 is a block diagram concerning a terminal according to the fifth embodiment of the invention; and

FIG. 30 is a block diagram concerning an information processing unit according to the sixth embodiment of the invention.

1. An electronic information retention method comprising the step of generating dummy files indistinguishable from split files generated by applying a reversible data conversion process, and a reversible data split process to electronic information to be retained, and the step of storing the split files together with the dummy files.

2. The invention provides another electronic information retention method comprising the step of generating a plurality of dummy data blocks by applying a reversible data conversion process, and a reversible data split process to non-secret information, the step of generating a plurality of dummy files by providing the respective dummy data blocks as generated with file names, and the step of storing split files generated by applying a reversible data conversion process, and a reversible data split process to electronic information to be retained, together with the dummy files.

3. The electronic information retention method as disclosed in claim 1, further comprising the step of determining whether or not the number of files stored is not less than a predetermined number, and the step of generating the dummy files such that the number of the files stored is not less than the predetermined number if it is determined that the number of the files stored is less than the predetermined number.

4. An electronic information split retention method comprising the step of generating a plurality of split data blocks by applying a reversible data conversion process, and a reversible data split process, selected at random, to electronic information to be retained, the step of generating a plurality of split files by providing the respective split data blocks with file names at random, the step of storing a plurality of the split files generated together with dummy files indistinguishable from the respective split files related thereto, and the step of storing split restoration information generated by relating processing information concerning the data conversion process, and the data split process, as selected, together with file names of the respective split files, and information on storage destinations thereof, to identification information on the electronic information.

5. An electronic information split retention method comprising the step of generating a plurality of split data blocks by applying a reversible data conversion process, and a reversible data split process, selected at random, to electronic information to be retained, the step of generating a plurality of split files by providing the respective split data blocks with file names at random, the step of generating a plurality of dummy data blocks by applying a reversible data conversion process, and a reversible data split process to non-secret information, the step of generating a plurality of dummy files by providing the respective dummy data blocks generated with file names, the step of storing a plurality of the split files together with the dummy files, and the and the step of storing split restoration information generated by relating processing information concerning the data conversion process, and the data split process, as selected, together with file names of the respective split files, and information on storage destinations thereof, to identification information on the electronic information.

6. The electronic information split retention method as disclosed in claim 4, wherein the split restoration information is stored at storage destinations different from the storage destinations of the respective split files.

7. The electronic information split retention method as disclosed in claim 4, wherein an encryption process is applied to the split restoration information before storing the split restoration information.

8. An electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of split files by providing the respective split data blocks with file names at random, the step of storing the plurality of the split files generated, together with dummy files indistinguishable from the respective split files, the step of storing split restoration information generated by relating processing information concerning the data conversion process, and the data split process, as selected, together with the file names of the respective split files, and information on storage destinations thereof, to identification information on the electronic information, the step of reading the split files on the basis of the file names of the respective split files, and the information on storage destinations thereof, contained in the relevant split restoration information corresponding to the identification information on the relevant electronic information, in response to a request for restoration of electronic information, and the step of executing restoration process for the split files as read on the basis of the processing information contained in the split restoration information.

9. An electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of split files by providing the respective split data blocks with file names at random, the step of generating a plurality of dummy data blocks by applying a reversible data conversion process, and a reversible data split process to non-secret information, the step of generating a plurality of dummy files by providing the respective dummy data blocks generated with file names, the step of storing the plurality of the split files together with the dummy files, the step of storing split restoration information generated by relating processing information concerning the data conversion process, and the data split process, as selected, together with the file names of the respective split files, and information on storage destinations thereof, to identification information on the electronic information, the step of reading the split files on the basis of the file names of the respective split files, and the information on storage destinations thereof, contained in the relevant split restoration information corresponding to the identification information on the relevant electronic information, in response to a request for restoration of electronic information, and the step of executing restoration process for the split files as read on the basis of the processing information contained in the split restoration information.

10. An electronic information retention system comprising a dummy file generation means for generating dummy files indistinguishable from split files generated by applying a reversible data conversion process, and a reversible data split process to electronic information, and a file storage means for storing the split files together with the dummy files.

11. An electronic information retention system comprising a dummy data generation means for generating a plurality of dummy data blocks by applying a reversible data conversion process, and a reversible data split process to non-secret information, a dummy file generation means for generating a plurality of dummy files by providing the respective dummy data blocks as generated, with file names, and a file storage means for storing a plurality of split files generated by applying a reversible data conversion process, and a reversible data split process to electronic information, together with the dummy files.

12. The electronic information retention system as disclosed in claim 10, further comprising a determination means for determining whether or not the number of files stored is not less than a predetermined number, and a file generation control means for generating the dummy files by controlling the dummy file generation means such that the number of the files stored is not less than the predetermined number if it is determined that the number of the files stored is less than the predetermined number.

13. An electronic information split retention system comprising a split data generation means for generating a plurality of split data blocks by applying a reversible data conversion process, and a reversible data split process to electronic information to be retained, a split file generation means for generating a plurality of split files by providing the respective split data blocks with file names, a file retention means for storing the plurality of the split files generated, together with dummy files indistinguishable from the respective split files, and a split restoration information generation means for generating split restoration information by relating processing information concerning the data conversion process, and the data split process, as selected, together with the file names of the respective split files, and information on storage destinations thereof, to identification information on the electronic information.

14. An electronic information split retention system comprising a split data generation means for generating a plurality of split data blocks by applying a reversible data conversion process, and a reversible data split process to electronic information to be retained, a split file generation means for generating a plurality of split files by providing the respective split data blocks with file names, a dummy data generation means for generating a plurality of dummy data blocks by applying a reversible data conversion process, and a reversible data split process to non-secret information, a dummy file generation means for generating a plurality of dummy files by providing the respective dummy data blocks as generated with file names, a file storage means for storing the plurality of the split files together with the dummy files, and a split restoration information generation means for generating split restoration information by relating processing information concerning the data conversion process, and the data split process, as selected, together with the file names of the respective split files, and information on storage destinations thereof, to identification information on the electronic information.

15. An electronic information split restoration processing system comprising a split data generation means for generating a plurality of split data blocks by applying a reversible data conversion process, and a reversible data split process, to electronic information to be retained, in response to a request for retention of the electronic information, a split file generation means for generating a plurality of split files by providing the respective split data blocks with file names, a file storage means for storing the plurality of the split files generated, together with dummy files indistinguishable from the respective split files, a split restoration information retention means for storing split restoration information generated by relating processing information concerning the data conversion process, and the data split process, as selected, together with the file names of the respective split files, and information on storage destinations thereof, to identification information on the electronic information, a split file collection means for reading the split files on the basis of the file names of the respective split files, and the information on storage destinations thereof, contained in the relevant split restoration information corresponding to the identification information on the relevant electronic information, in response to a request for restoration of electronic information, and a restoration processing means for executing restoration process for the split files as read on the basis of the processing information contained in the split restoration information.

16. An electronic information split restoration processing system comprising a split data generation means for generating a plurality of split data blocks by applying a reversible data conversion process, and a reversible data split process, to electronic information to be retained, in response to a request for retention of the electronic information, a split file generation means for generating a plurality of split files by providing the respective split data blocks with file names, a dummy data generation means for generating a plurality of dummy data blocks by applying a reversible data conversion process, and a reversible data split process to non-secret information, a dummy file generation means for generating a plurality of dummy files by providing the respective dummy data blocks generated, with file names, a file storage means for storing the plurality of the split files together with the dummy files, a split restoration information retention means for storing split restoration information generated by relating processing information concerning the data conversion process, and the data split process, as selected, together with the file names of the respective split files, and information on storage destinations thereof, to identification information on the electronic information, a split file collection means for reading the split files on the basis of the file names, and the information on storage destinations, contained in the relevant split restoration information corresponding to the identification information on the relevant electronic information, in response to a request for restoration of electronic information, and a restoration processing means for executing a restoration process for the split files as read on the basis of the processing information contained in the split restoration information.

17. A program for enabling an electronic information retention system capable of storing a plurality of split files generated by applying a reversible data conversion process, and a reversible data split process to electronic information to be retained to function, said program causing the electronic information retention system to function as:
a means for generating dummy files indistinguishable from the split files; and a means for storing the split files together with the dummy files.

18. A program for enabling an electronic information retention system capable of storing a plurality of split files generated by applying a reversible data conversion process, and a reversible data split process to electronic information to be retained to function, said program causing the electronic information retention system to function as:
a means for generating a plurality of dummy data blocks by applying a reversible data conversion process, and a reversible data split process to non-secret information;
a means for generating a plurality of dummy files by providing the respective dummy data blocks as generated, with file names; and
a means for storing the split files together with the dummy files.

19. The program as disclosed in claim 17 for causing the electronic information retention system to function further as:
a means for determining whether or not the number of files stored is not less than a predetermined number; and
a means for controlling such that the dummy files are generated until the number of the files stored is not less than the predetermined number if it is determined that the number of the files stored is less than the predetermined number.

20. A program for enabling an electronic information split retention system for splitting and storing electronic information to function, said program causing the electronic information split retention system to function as:
a means for generating a plurality of split data blocks by applying a reversible data conversion process, and a reversible data split process to electronic information to be retained,
a means for generating a plurality of split files by providing the respective split data blocks, with file names;
a means for storing the plurality of the split files generated, together with dummy files indistinguishable from the respective split files; and
a means for generating split restoration information by relating processing information concerning the data conversion process, and the data split process, as selected, together with the file names of the respective split files, and information on storage destinations thereof, to identification information on the electronic information.

21. A program for enabling an electronic information split retention system for splitting and storing electronic information to function, said program causing the electronic information split retention system to function as:
a means for generating a plurality of split data blocks by applying a reversible data conversion process, and a reversible data split process to electronic information to be retained;
a means for generating a plurality of split files by providing the respective split data blocks with file names;
a means for generating a plurality of dummy data blocks by applying a reversible data conversion process, and a reversible data split process to non-secret information;
a means for generating a plurality of dummy files by providing the respective dummy data blocks as generated, with file names;
a means for storing the plurality of the split files together with the dummy files; and
a means for generating split restoration information by relating processing information concerning the data conversion process, and the data split process, as selected, together with the file names of the respective split files, and information on storage destinations thereof, to identification information on the electronic information.

22. A program for enabling an electronic information split restoration processing system for splitting and storing electronic information, and restoring the electronic information as split to function, said program causing the electronic information split restoration processing system to function as:
a means for generating a plurality of split data blocks by applying a reversible data conversion process, and a reversible data split process to electronic information to be retained, in response to a request for retention of electronic information;
a means for generating a plurality of split files by providing the respective split data blocks, with file names:
a means for storing the plurality of the split files generated, together with dummy files indistinguishable from the respective split files;
a means for storing split restoration information generated by relating processing information concerning the data conversion process, and the data split process, as selected, together with the file names of the respective split files, and information on storage destinations thereof, to identification information on the electronic information;
a means for reading the split files on the basis of the file names, and the information on storage destinations, contained in the relevant split restoration information corresponding to the identification information on the relevant electronic information, in response to a request for restoration of electronic information; and
a means for executing a restoration process for the split files as read on the basis of the processing information contained in the split restoration information.

23. A program for enabling an electronic information split restoration processing system for splitting and storing electronic information, and restoring the electronic information as split to function, said program causing the electronic information split restoration processing system to function as:
a means for generating a plurality of split data blocks by applying a reversible data conversion process, and a reversible data split process to electronic information to be retained, in response to a request for retention of the electronic information;
a means for generating a plurality of split files by providing the respective split data blocks with file names;
a means for generating a plurality of dummy data blocks by applying a reversible data conversion process, and a reversible data split process to non-secret information;
a means for generating a plurality of dummy files by providing the respective dummy data blocks generated, with file names;
a means for storing the plurality of the split files generated, together with the dummy files;
a means for storing split restoration information generated by relating processing information concerning the data conversion process, and the data split process, as selected, together with the file names of the respective split files, and information on storage destinations thereof, to identification information on the electronic information;
a means for reading the split files on the basis of the file names, and the information on storage destinations, contained in the relevant split restoration information corresponding to the identification information on the relevant electronic information, in response to a request for restoration of electronic information; and
a means for executing a restoration process for the split files as read on the basis of the processing information contained in the split restoration information.

24. An electronic information retention method comprising the step of generating dummy data blocks indistinguishable from respective split data blocks generated by applying a reversible data conversion process, and a reversible data split process to electronic information to be retained, and the step of storing the split data blocks, together with the dummy data blocks, in a database.

25. An electronic information retention method comprising the step of generating a plurality of dummy data blocks by applying a reversible data conversion process, and a reversible data split process to non-secret information, and the step of storing split data blocks generated by applying a reversible data conversion process, and a reversible data split process to electronic information to be retained, together with the dummy data blocks, in a database.

26. The electronic information retention method as disclosed in claim 24, further comprising the step of determining whether or not the number of data blocks stored in the database is not less than a predetermined number, and the step of generating the dummy blocks such that the number of the data blocks stored is not less than the predetermined number if it is determined that the number of the data blocks stored is less than the predetermined number.

27. An electronic information split retention method comprising the step of generating a plurality of split data blocks by applying a reversible data conversion process, and a reversible data split process, selected at random, to electronic information to be retained, the step of storing the plurality of the split data blocks generated, together with dummy files indistinguishable from the respective split data blocks, and the step of storing split restoration information generated by relating processing information concerning the data conversion process, and the data split process, as selected, together with information on storage locations of the respective split data blocks, and information on storage destinations thereof, to identification information on the electronic information.

28. An electronic information split retention method comprising the step of generating a plurality of split data blocks by applying a reversible data conversion process, and a reversible data split process, selected at random, to electronic information to be retained, the step of generating a plurality of dummy data blocks by applying a reversible data conversion process, and a reversible data split process to non-secret information, the step of storing the split data blocks generated, together with the dummy data blocks, in a database, and the step of storing split restoration information generated by relating processing information concerning the data conversion process, and the data split process, as selected, together with information on storage locations of the respective split data blocks, and information on storage destinations thereof, to identification information on the electronic information.

29. The electronic information split retention method as disclosed in claim 27, wherein the split restoration information is stored at storage destinations different from the storage destinations of the respective split data blocks.

30. The electronic information split retention method as disclosed in claim 27, wherein an encryption process is applied to the split restoration information before storing the split restoration information.

31. An electronic information split restoration processing method comprising the step of generating a plurality of split data blocks by applying a reversible data conversion process, and a reversible data split process, selected at random, to electronic information to be retained in response to a request for retention of the electronic information, the step of storing the plurality of the split data blocks generated, together with dummy data blocks indistinguishable from the respective split data blocks, in database, the step of storing split restoration information generated by relating processing information concerning the data conversion process, and the data split process, as selected, together with information on storage locations of the respective split data blocks, and information on storage destinations thereof, to identification information on the electronic information, the step of reading the split data blocks on the basis of the information on the storage locations of the respective split data blocks, and the information on storage destinations thereof, contained in the relevant split restoration information corresponding to the identification information on the relevant electronic information, in response to a request for restoration of electronic information, and the step of executing a restoration process for the split data blocks as read on the basis of the processing information contained in the split restoration information.

32. An electronic information split restoration processing method comprising the step of generating a plurality of split data blocks by applying a reversible data conversion process, and a reversible data split process, selected at random, to electronic information to be retained in response to a request for retention of the electronic information, the step of generating a plurality of dummy data blocks by applying a reversible data conversion process, and a reversible data split process to non-secret information, the step of storing the plurality of the split data blocks generated, together with the dummy data blocks, in a database, the step of storing split restoration information generated by relating processing information concerning the data conversion process, and the data split process, as selected, together with information on storage locations of the respective split data blocks, and information on storage destinations thereof, to identification information on the electronic information, the step of reading the split data blocks on the basis of the information on the storage locations of the respective split data blocks, and the information on storage destinations thereof, contained in the relevant split restoration information corresponding to the identification information on the relevant electronic information, in response to a request for restoration of electronic information, and the step of executing a restoration process for the split data blocks as read on the basis of the processing information contained in the split restoration information.

33. An electronic information retention system comprising a dummy data generation means for generating dummy data blocks indistinguishable from a plurality of split data blocks generated by applying a reversible data conversion process, and a reversible data split process, to electronic information to be retained, and a data storage means for storing the split data blocks together with the dummy data blocks, in a database.

34. An electronic information retention system comprising a dummy data generation means for generating a plurality of dummy data blocks by applying a reversible data conversion process, and a reversible data split process to non-secret information, and a data storage means for storing a plurality of split data blocks generated by applying a reversible data conversion process, and a reversible data split process to electronic information to be retained, together with the dummy data blocks, in a database.

35. The electronic information retention system as disclosed in claim 33 further comprising a determination means for determining whether or not the number of data blocks stored in the database is less than a predetermined number, and a data generation control means for generating the dummy data blocks by controlling the dummy data generation means such that the number of the data blocks stored is not less than the predetermined number if it is determined that the number of the data blocks stored is less than the predetermined number.

36. An electronic information split retention system comprising a split data generation means for generating a plurality of split data blocks by applying a reversible data conversion process, and a reversible data split process to electronic information to be retained, a data storage means for storing the plurality of the split data blocks, together with dummy data blocks indistinguishable from the respective split data blocks, in a database, and a split restoration information generation means for generating split restoration information by relating processing information concerning the data conversion process, and the data split process, as selected, together with information on storage locations of the respective split data blocks, and information on storage destinations thereof, to identification information on the electronic information.

37. An electronic information split retention system comprising a split data generation means for generating a plurality of split data blocks by applying a reversible data conversion process, and a reversible data split process to electronic information to be retained, a dummy data generation means for generating a plurality of dummy data blocks by applying a reversible data conversion process, and a reversible data split process to non-secret information, a data storage means for storing the plurality of the split data blocks generated, together with the dummy data blocks, in a database, and a split restoration information generation means for generating split restoration information by relating processing information concerning the data conversion process, and the data split process, as selected, together with information on storage locations of the respective split data blocks, and information on storage destinations thereof, to identification information on the electronic information.

38. An electronic information split restoration processing system, comprising a split data generation means for generating a plurality of split data blocks by applying a reversible data conversion process, and a reversible data split process to electronic information to be retained, in response to a request for retention of the electronic information, a data storage means for storing the plurality of the split data blocks generated, together with dummy data blocks indistinguishable from the respective split data blocks, in a database, a split restoration information retention means for storing split restoration information generated by relating processing information concerning the data conversion process, and the data split process, as selected, together with information on storage locations of the respective split data blocks, and information on storage destinations thereof, to identification information on the electronic information, a split data collection means for reading the split data blocks on the basis of the information on the storage locations of the respective split data blocks, and the information on the storage destinations thereof, contained in the relevant split restoration information corresponding to the identification information on the relevant electronic information, in response to a request for restoration of electronic information, and a restoration processing means for executing a restoration process for the split data blocks as read on the basis of the processing information contained in the split restoration information.

39. An electronic information split restoration processing system, comprising a split data generation means for generating a plurality of split data blocks by applying a reversible data conversion process, and a reversible data split process to electronic information to be retained, in response to a request for retention of the electronic information, a dummy data generation means for generating a plurality of dummy data blocks by applying a reversible data conversion process, and a reversible data split process to non-secret information, a data storage means for storing the plurality of the split data blocks together with the dummy data blocks, in a database, a split restoration information retention means for storing split restoration information generated by relating processing information concerning the data conversion process, and the data split process, as selected, together with information on storage locations of the respective split data blocks, and information on storage destinations thereof, to identification information on the electronic information, a split data collection means for reading the split data blocks on the basis of the information on the storage locations of the respective split data blocks, and the information on the storage destinations thereof, contained in the relevant split restoration information corresponding to the identification information on the relevant electronic information, in response to a request for restoration of electronic information, and a restoration processing means for executing a restoration process for the split data blocks as read on the basis of the processing information contained in the split restoration information.

40. A program for enabling an electronic information retention system capable of storing a plurality of split data blocks generated by applying a reversible data conversion process, and a reversible data split process to electronic information to be retained, in a database, to function, said program causing the electronic information retention system to function as:
a means for generating dummy data blocks indistinguishable from the split data blocks; and
a means for storing the split data blocks, together with the dummy data blocks, in the database.

41. A program for enabling an electronic information retention system capable of storing a plurality of split data blocks generated by applying a reversible data conversion process, and a reversible data split process to electronic information to be retained, in a database, to function, said program causing the electronic information retention system to function as:
a means for generating a plurality of dummy data blocks by applying a reversible data conversion process, and a reversible data split process to non-secret information; and
a means for storing the split data blocks together with the dummy data blocks, in the database.

42. Said program as disclosed in claim 40 causes the electronic information retention system to function further as a means for determining whether or not the number of data blocks stored in the database is less than a predetermined number, and a means for controlling such that the dummy data blocks are generated until the number of the data blocks stored is not less than the predetermined number if it is determined that the number of the data blocks stored is less than the predetermined number.

43. A program for enabling an electronic information split retention system for splitting electronic information to be stored in a database, to function, said program causing the electronic information retention system to function as:
a means for generating a plurality of split data blocks by applying a reversible data conversion process, and a reversible data split process to electronic information to be retained;
a means for storing the plurality of the split data blocks generated, together with dummy data blocks indistinguishable from the respective split data blocks, in the database; and
a means for generating split restoration information by relating processing information concerning the data conversion process, and the data split process, as selected, together with information on storage locations of the respective split data blocks, and information on storage destinations thereof, to identification information on the electronic information.

44. A program for enabling an electronic information split retention system for splitting electronic information to be stored in a database, to function, said program causing the electronic information retention system to function as:
a means for generating a plurality of split data blocks by applying a reversible data conversion process, and a reversible data split process to electronic information to be retained;
a means for generating a plurality of dummy data blocks by applying a reversible data conversion process, and a reversible data split process to non-secret information;
a means for storing the split data blocks generated, together with the dummy data blocks, in the database; and
a means for generating split restoration information by relating processing information concerning the data conversion process, and the data split process, as selected, together with information on storage locations of the respective split data blocks, and information on storage destinations thereof, to identification information on the electronic information.

45. A program for enabling an electronic information split restoration processing system for splitting electronic information to be stored in a database, and restoring the electronic information as split, said program causing the electronic information split restoration processing system to function as:
a means for generating a plurality of split data blocks by applying a reversible data conversion process, and a reversible data split process to electronic information to be retained, in response to a request for retention of the electronic information;
a means for storing the plurality of the split data blocks generated, together with dummy data blocks indistinguishable from the respective split data blocks, in the database;
a means for storing split restoration information generated by relating processing information concerning the data conversion process, and the data split process, as selected, together with information on storage locations of the respective split data blocks, and information on storage destinations thereof, to identification information on the electronic information;
a means for reading the split data blocks on the basis of the information on the storage locations, and the information on the storage destinations, contained in the relevant split restoration information corresponding to the identification information on the relevant electronic information, in response to a request for restoration of the electronic information; and
a means for executing a restoration process for the split data blocks as read on the basis of the processing information contained in the split restoration information.

46. A program for enabling an electronic information split restoration processing system for splitting electronic information to be stored in a database, and restoring the electronic information as split, said program causing the electronic information split restoration processing system to function as:
a means for generating a plurality of split data blocks by applying a reversible data conversion process, and a reversible data split process to electronic information to be retained, in response to a request for retention of the electronic information;
a means for generating a plurality of dummy data blocks by applying a reversible data conversion process, and a reversible data split process to non-secret information;
a means for storing the plurality of the split data blocks generated, together with the dummy data blocks, in the database;
a means for storing split restoration information generated by relating processing information concerning the data conversion process, and the data split process, as selected, together with information on storage locations of the respective split data blocks, and information on storage destinations thereof, to identification information on the electronic information;
a means for reading the split data blocks on the basis of the information on the storage locations, and the information on the storage destinations, contained in the relevant split restoration information corresponding to the identification information on the relevant electronic information, in response to a request for restoration of the electronic information; and
a means for executing a restoration process for the split data blocks as read on the basis of the processing information contained in the split restoration information.
